(19) United States
(12) Patent Application Publication
(10) Pub. No.: US 2023/0268494 A1
(43) Pub. Date: Aug. 24, 2023

(54) SILICON-BASED ANODE MATERIAL AND PREPARATION METHOD THEREFOR, AND SECONDARY BATTERY

(71) Applicant: SHENZHEN DYNANONIC CO., LTD., Shenzhen (CN)

(72) Inventors: Zeqin ZHONG, Shenzhen (CN); Yuanxin WAN, Shenzhen (CN); Lingyong KONG, Shenzhen (CN); Wangbao REN, Shenzhen (CN); Chengben ZHU, Shenzhen (CN); Yucai ZHANG, Shenzhen (CN); Shaozhen HUANG, Shenzhen (CN)

(73) Assignee: SHENZHEN DYNANONIC CO., LTD., Shenzhen (CN)

(21) Appl. No.: 18/305,610

(22) Filed: Apr. 24, 2023

Related U.S. Application Data
(63) Continuation-in-part of application No. PCT/CN2021/076384, filed on Feb. 9, 2021.

(30) Foreign Application Priority Data
Oct. 26, 2020 (CN) 202011157895.1

(51) Int. Cl. H01M 4/38; H01M 10/0525; H01M 4/48; H01M 4/36; H01M 4/04

(52) U.S. Cl. CPC H01M 4/386; H01M 10/0525; H01M 4/48; H01M 4/366; H01M 4/0404; H01M 4/0428; H01M 4/0423; H01M 4/0471; H01M 4/0452; H01M 2004/021

(57) ABSTRACT

A silicon-based anode material, including a silicon-based core; and a shell layer arranged on the silicon-based core, the silicon-based core comprises SiOₓ and silicon microcrystals dispersed in the SiOₓ, where 0.9≤x≤1.3; and a distribution density of the silicon microcrystals gradually decreases along a direction from a surface of the silicon-based core to the center of the silicon-based core, the shell layer includes a carbon layer. The silicon-based anode material has high capacity and low volume expansion effect, and the battery capacity and cycle performance can be improved in the applications in non-aqueous electrolyte secondary batteries. A preparation method for a silicon-based anode material for lithium-ion batteries.

### CROSS-REFERENCE TO RELATED APPLICATIONS

This application is a continuation-in-part of International Patent Application No. PCT/CN2021/076384 with an international filing date of Feb. 9, 2021, designating the U.S., now pending, and further claims the benefit of Chinese patent application No. 202011157895.1, filed on Oct. 26, 2020, the contents of all of the aforementioned applications, including any intervening amendments thereto, are incorporated herein by reference.

### TECHNICAL FIELD

The present application relates to the field of lithium-ion batteries, and in particular, relates to a silicon-based anode material and a preparation method therefor, and a secondary battery.

### BACKGROUND

With increasing public awareness of environmental protection and energy crisis, lithium-ion batteries become more and more popular as a green and environmental-friendly energy storage technology. Lithium-ion batteries are widely used in products such as mobile phones, ipads, laptops, and automobiles because of their high working voltage, high capacity densities, low self-discharge level, and long cycle life, as well as their exhibiting no memory effect, nor heavy metal pollution such as lead and cadmium. As an essential part of lithium-ion batteries, the anode of lithium-ion batteries affects the specific energy and cycle life of lithium-ion batteries. With the widespread application of electronic products and the vigorous development of electric vehicles, the lithium-ion batteries market also grows, along with increasing requirements for the safety of lithium-ion batteries.

Existing commercial lithium-ion batteries mainly adopt graphite-based anode materials, however, its theoretical specific capacity is only 372 mAh/g, which cannot meet the market demand for a high capacity density of lithium-ion batteries.

At present, silicon-based anode materials are ideal high-capacity anode materials for lithium-ion batteries due to their high theoretical specific capacities and a suitable lithium intercalation potentials. However, during charging and discharging, the volume change of silicon reaches more than 300%, and the internal stress generated by the dramatic volume change easily leads to powdering and peeling of the electrode, which affects the cycle stability. At the same time, the high surface activity of the silicon-based anode material will cause the electrolyte to be prone to decomposition, thus adverse phenomena, such as decomposition or/and fire and the like, of the active components of the electrolyte are likely to occur during the charging and discharging process of the lithium-ion batteries, therefore, the electrochemical performance of the lithium-ion batteries is unstable, and the cycling performance and safety thereof are not ideal.

### Technical Problems

In order to tackle the above-mentioned technical problems that the existing silicon-based anode material has high surface activity, which leads to easy decomposition of the electrolyte and unsatisfactory cycling performance, the present application provides a silicon-based anode material and a preparation method therefor, and a secondary battery.

Another objective of the present application is to provide an anode and a lithium-ion battery containing the anode, so as to solve the problems of unstable electrochemical performance, and unsatisfactory cycling performance and safety in the existing lithium-ion batteries containing a silicon-based anode.

### Technical Proposals

An aspect of the present application provides a silicon-based anode material, which includes a silicon-based core and a shell layer arranged on the silicon-based core, where the silicon-based core includes SiOₓ and silicon microcrystals dispersed in the SiOₓ, and where 0.9≤x≤1.3; and the distribution density of the silicon microcrystals gradually decreases along a direction from a surface of the silicon-based core to the center of the silicon-based core, the shell layer includes a carbon layer.

Another aspect of the present application provides a preparation method for a silicon-based anode material. The preparation method of the silicon-based anode material includes the following steps:
carrying out a dynamic heat treatment on silicon monoxide to obtain a silicon-based core, the silicon-based core includes SiOₓ and microcrystals dispersed in SiOₓ, where 0.9≤x≤1.3; and the distribution density of the silicon microcrystals gradually decreases along a direction from a surface of the silicon-based core to the center of the silicon-based core; and
forming a shell layer including a carbon layer on the silicon-based core to obtain a silicon-based anode material.

Yet another aspect of the present application provides an anode. The anode includes a current collector and a silicon-based active layer bonded on a surface of the current collector, the silicon-based active layer contains the silicon-based anode material of the present application or a silicon-based anode material prepared by the preparation method for a silicon-based anode material of the present application.

Still another aspect of the present application provides a lithium-ion battery, which includes an anode, and the anode is the anode according to the present application.

### Advantageous Effects

The advantageous effects of the present application in comparison to the existing technologies are as follows:

The silicon-based anode material of the present application, with the distribution density of the silicon microcrystals gradually decreasing along a direction from a surface of the silicon-based core to the center of the silicon-based core, effectively inhibits the volume expansion of silicon microcrystals in the intercalation of lithium, prevents stress concentrations in the center of the silicon-based core, thereby inhibiting the breakage of silicon-based anode materials, and effectively ensuring the cycle life of the lithium-ion battery. SiOₓ in the silicon-based core can disperse the stress generated by the volume expansion of silicon microcrystals, thereby forming a silicon-based anode material having a stable structure. On the one hand, the carbon layer can enhance the conductivity of the silicon-based anode material; on the other hand, the carbon layer acts as a buffer skeleton, which can weaken the influence of the volume expansion of the silicon microcrystals on the silicon-based anode material, inhibit the volume expansion effect of the silicon microcrystals, and enhance the structural stability of the silicon-based anode material so as to effectively improve the cycling performance of the silicon-based anode material. Therefore, the silicon-based anode material has both sufficient capacity and good cycling stability through the structure provided therein.

The preparation method of a silicon-based anode material of the present application prepares a silicon-based core having a distribution density of the silicon microcrystals gradually decreasing along a direction from a surface of the silicon-based core to the center of the silicon-based core through the disproportionation reaction of silicon monoxide under high temperature; and forms a shell layer including a carbon layer on the silicon-based core to obtain a silicon-based anode material. The preparation method of a silicon-based anode material has a simple process, low energy consumption, and is environmentally friendly and non-polluting; the silicon-based anode material prepared has a relatively low volume expansion effect, large capacity, and good cycling performance, and is stable, thus is capable of improving the cycle stability of the lithium-ion battery when applied thereto.

Since the anode of the present application and the secondary battery containing the anode of the present application both contain the silicon-based anode material of the present application, the cycling performance thereof is excellent, and the energy density is high, and the internal resistance is low, thereby the secondary battery of the present application exhibits an excellent cycle performance, long service life, high specific capacity, stable electrochemical performance, and reliable safety.

### BRIEF DESCRIPTION OF THE DRAWINGS

In order to more clearly illustrate the technical proposals in embodiments of the present application, accompanying drawings that are used in the description of the embodiments or exemplary existing technologies are briefly introduced hereinbelow. Obviously, the drawings in the following description are merely some embodiments of the present application. For those skilled in the art, other drawings can also be obtained according to these drawings without any creative effort.

FIG. 1 is a schematic diagram showing the structure of the silicon-based anode material according to an embodiment of the present application;

FIG. 2 is a schematic diagram showing the structure of the silicon-based anode material according to another embodiment of the present application;

FIG. 3 is a schematic diagram showing the structure of the silicon-based anode material according to another embodiment of the present application;

FIG. 4 is a schematic diagram showing the structure of the silicon-based anode material according to another embodiment of the present application;

FIG. 5 is a schematic diagram showing the structure of the silicon-based anode material according to another embodiment of the present application;

FIG. 6 is a schematic diagram showing the structure of the silicon-based anode material according to another embodiment of the present application;

FIG. 7 is a schematic diagram showing the structure of the silicon-based anode material according to another embodiment of the present application;

FIG. 8 is a schematic diagram showing the structure of the silicon-based anode material according to another embodiment of the present application;

FIG. 9 is a schematic diagram showing the structure of the silicon-based anode material according to another embodiment of the present application;

FIGS. 10A-10E are HRTEM images of the silicon-based anode materials according to Example 1 and Comparative Example 1 of the present application, where FIG. 10A shows a cross-section of the silicon-based anode materials according to Example 1, FIGS. 10C-10E are respectively a HRTEM of the silicon-based anode material at location 1, 2, and 3 in FIG. 10A, and FIG. 10B is a spectrum obtained by FFT Fourier transform of the white-bordered area in FIG. 10C;

FIGS. 11A-118 are TEM images of the silicon-based anode materials according to Comparative Example 1, where FIG. 11A is a HRTEM image of the silicon-based anode materials according to Comparative Example 1, FIG. 11B is a spectrum obtained by FFT Fourier transform of the white-bordered area in FIG. 11A; and

FIG. 12 shows a comparison between the XRD results of Example 1 and Comparative Example 1.

### DETAILED DESCRIPTION OF THE EMBODIMENTS

Described below is the preferred embodiment of the present application, it should be noted that, for those of ordinary skill in the art, without departing from the principle of the present application, improvements and modifications can also be made, these improvements and modifications also fall within the scope of protection of this application.

In order to more clearly understand the technical problems, technical proposals, and advantageous effects of the present application, the present application will be described in further detail hereinbelow with reference to the embodiments. It should be understood that the detailed embodiments described herein are merely to explain the present application, but not to limit the present application.

In this application, the term “and/or”, which describes the relationship between related objects, means that there can be three relationships, for example. A and/or B, which can represent circumstances that A exists alone, A and B exist at the same time, and B exists alone, where A and B can be singular or plural. The character “/” generally indicates that the associated objects are in an “or” relationship.

In this application, “at least one” means one or more, and “a plurality of” means two or more. “At least one item below” or similar expressions refer to any combination of these items, including any combination of single item or plural items. For example, “at least one of a, b, or c” can mean: a, b, c, a-b (i.e., a and b), a-c, b-c, or a-b-c, where a, b, and c can be singular or plural respectively.

It should be understood that, in various embodiments of the present application, the numbers of the above-mentioned processes do not imply the sequence of execution, some or all of the steps may be executed in parallel or sequentially, and the execution sequence of each process should be based on its functions and determined by the internal logic, and should not constitute any limitation on the implementation process of the embodiments of the present application.

The terms used in the embodiments of the present application are merely for the purpose of describing specific embodiments, and are not intended to limit the present application. Unless clearly dictated otherwise, the singular forms “a”, “the” and “said” as used in the embodiments of this application and the appended claims intended to include the plural forms as well.

The weight of the relevant compositions mentioned in the examples of this application can not only refer to the specific content of each composition, but also represent the proportional relationship between the weights of the compositions. It is within the scope disclosed in the embodiments of the present application that the content of the compositions is proportionally scaled up or down. Specifically, the mass described in the description of the embodiments of the present application may be a mass unit known in the chemical field, such as μg, mg, g, and kg.

The terms “first” and “second” are merely used for descriptive purposes to distinguish objects such as substances from each other, and cannot be understood as indicating or implying relative importance or implying the number of indicated technical features. For example, without departing from the scope of the embodiments of the present application, “the first” may also be referred to as “the second”, and similarly, “the second” may also be referred to as “the first”. Thus, a feature defined as “first” or “second” may expressly or implicitly include one or more of the features.

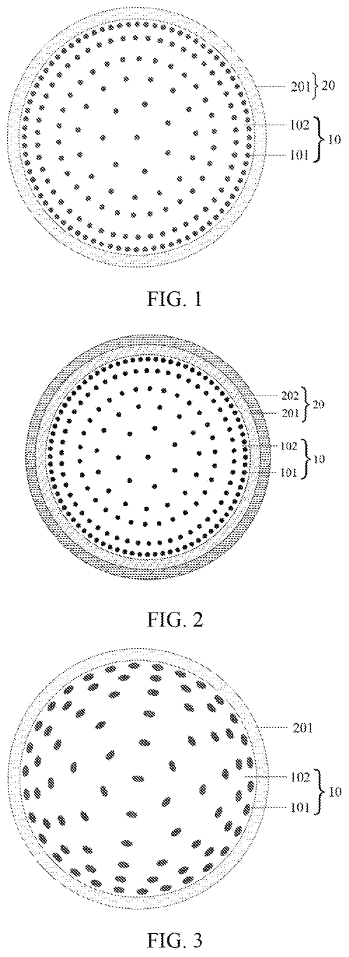

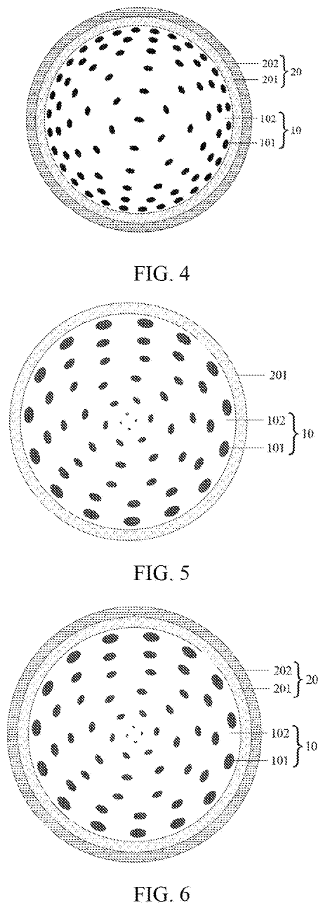

An embodiment of the present application provides a silicon-based anode material, referring to FIGS. 1 to 9, the silicon-based anode material includes a silicon-based core 10 and a shell layer 20 arranged on the silicon-based core 10. The silicon-based core 10 includes silicon microcrystals 101 and SiOₓ 102, and the distribution density of the silicon microcrystals 101 gradually decreases along a direction from the shell layer 20 to the center of the silicon-based core 10. The shell layer 20 includes a carbon layer 201.

In an embodiment, the silicon microcrystals 101 may be arranged in the silicon-based core 10 in the array arrangement as shown in FIGS. 1 and 2, or may be arranged in the silicon-based core 10 in the array arrangement as shown in FIGS. 3 to 9, or may be arranged in other arrangements as long as the distribution density of the silicon microcrystals gradually decreases along a direction from a surface of the silicon-based core to the center of the silicon-based core. In this embodiment, the direction from the surface of the silicon-based core 10 to the center of the silicon-based core 10 is the same as an inward direction from the surface of the silicon-based core 10 and a direction from the shell layer 20 to the center of the silicon-based core 10. In the embodiments, the distribution density of the silicon microcrystals 101 gradually decreases along the direction from the surface of the silicon-based core 10 to the center of the silicon-based core 10 refers to a gradually decreasing tendency of the distribution density of the silicon microcrystals 101 along the direction from the surface of the silicon-based core 10 to the center of the silicon-based core 10.

Due to the distribution density of the silicon microcrystals 101 in the silicon-based anode material gradually decreasing along the direction from the surface of the silicon-based core 10 to the center of the silicon-based core 10, the distribution structure can prevent stress concentrations in the center of the silicon-based core 10, thereby inhibiting the irreversible increase in the capacity caused by breakage of the silicon-based anode material, and effectively improve the stability of the cycling performance. SiOₓ 102 as a matrix component in the silicon-based core 10 can disperse the stress generated by the volume expansion of silicon microcrystals 101, thereby forming a silicon-based anode material having a stable structure; the carbon layer 201 can not only enhance the conductivity of the silicon-based anode material, yet also inhibit the volume expansion effect of the silicon microcrystals 101, thereby enhancing the cycling performance of the silicon-based anode material. With the above arrangement, the silicon-based anode material can possess not only sufficient capacity, but also good cycle stability. In an embodiment, the shape of the silicon microcrystals 101 includes one or more of a sphere, an ellipsoid, and an irregular polyhedron. In an embodiment, the shape of the silicon-based anode material includes one or more of a sphere, an ellipsoid, and an irregular polyhedron.

The silicon microcrystals 101 in the silicon-based anode material can improve the first cycle charge-discharge capacity of the silicon-based anode material. In an embodiment, the ratio between the distribution densities of silicon microcrystals 101 on the surface of the silicon-based core 10, Dₒᵤₜ₁, and silicon microcrystals 101 at a depth of 500 nm from the surface of the silicon-based core 10 toward the center of the silicon-based core 10, Dᵢₙ₁, is 0≤Dᵢₙ₁/Dₒᵤₜ₁<1. By controlling the distribution density of the silicon microcrystals 101 in the silicon-based core 10 to gradually decrease along the direction from the surface to the center of the silicon-based core 10, the stress caused by expansion can be effectively dispersed, thereby inhibiting the break of the silicon-based anode material and ensuring the structural stability of silicon-based anode material.

In an embodiment, the particle sizes of the silicon microcrystals 101 are measured to be 1 nm-20 nm, further 1 nm-10 nm, and even further 3 nm-S nm. The particle sizes of the silicon microcrystals 101 can be obtained by X-ray diffraction of the silicon-based anode material, and calculated from the of Si(111) diffraction peak and its half-peak width using the Scherrer formula (Debye-Scherrer formula). By controlling the size of the silicon microcrystals 101, the particle agglomeration thereof can be effectively reduced, so that the silicon microcrystals 101 show a monodisperse distribution, thereby effectively dispersing the stress generated in the silicon-based anode material during the charging and discharging process, reducing the volume expansion effect of the silicon microcrystals 101, and improving the cycling performance of the silicon-based anode material.

In an embodiment, the particle sizes of the silicon microcrystals 101 on the outermost layer, that is, the surface of the silicon-based core 10 are 8 nm-10 nm. The particle sizes of the silicon microcrystals 101 on the surface of the silicon-based core 10 can be obtained by HRTEM (high-resolution transmission electron microscope). In some embodiments, the silicon microcrystals 101 in the silicon-based core 10 have a uniform and similar size. Furthermore, the size differences of the silicon microcrystals 101 at different positions in the silicon-based core 10 are less than or equal to 2 nm.

In other embodiments, the size of the silicon microcrystals 101 decreases gradually along the direction from the surface layer of the silicon-based core 10 to the center of the silicon-based core 10, in other words, the size of the silicon microcrystals 101 increases gradually in the direction from the center of the silicon-based core 10 to the surface of the silicon-based core 10, as shown in FIGS. 5 to 9. This allows the significant stress generated by volume expansion during the lithium intercalation process to be released outward, so as to inhibit the volume expansion and the breakage of the silicon-based anode material, reduce the resulting irreversible increase in the capacity, and effectively improve the service life of the silicon-based anode material. In the embodiments, the size difference of the silicon microcrystals 101 at the same depth from the surface of the silicon-based core 10 toward the center thereof is less than or equal to 0.5 nm.

In some embodiments, the particle size of the silicon microcrystals 101 on the surface of the silicon-based core 10 is referred to as Dowa, and the particle size of the silicon microcrystals 101 at the depth of 500 nm from the surface is referred to as Dᵢₙ₂, and Dₒᵤₜ₂ and Dᵢₙ₂ satisfy: 0≤Dᵢₙ₂/Dₒᵤₜ₂<1. By controlling the distribution density of the silicon microcrystals 101 in the silicon-based core 10 as such, the significant stress generated by volume expansion during the lithium intercalation process can be released outward, so as to inhibit the breakage of the particles, thereby reducing the resulting irreversible increase in the capacity, and effectively improving the structural stability of the silicon-based anode material and the cycle life of the battery. Here, Dₒᵤₜ₂ and Dᵢₙ₂ are measured by the high-resolution transmission electron microscope (HRTEM) after being cut by the focused ion beam (FIB). It should be understood that the above-mentioned size is the size indicating the particles, such as the particle size and the like.

In an embodiment, in any cross-section of the silicon-based anode material, the total area of the silicon microcrystals 101 accounts for 1%-23% of the total area of the silicon-based core 10, and further, 2-20 wt %. The total area of the silicon microcrystals 101 within the above range allows a higher charge-discharge capacity of the silicon-based anode material and reduces the volume expansion effect of the microcrystals 101. Moreover, the silicon microcrystals 101 content within this range exhibits a proper disproportionation effect, which improves the initial coulombic efficiency and capacity. It has been found that if the content of silicon microcrystals 101 is too low, a disproportionation effect will not be achieved, that is, if the content of amorphous silicon oxides is too high, too much active lithium ions will be consumed thus reducing the initial coulombic efficiency; whereas if the content of the silicon microcrystals 101 is too high, that is, an excessive disproportionation, the reversible capacity of the battery will be low. The ratio of the total area of the silicon microcrystals 101 to the area of the silicon-based core 10 may be calculated by the following method: the silicon-based anode material was cut using FIB (focused ion beam) to obtain a cross-section of the silicon-based anode material passing through the center point thereof; a HRTEM image of the cross-section of the silicon-based anode material was obtained by characterization of the cross-section using HRTEM; the black particles in the silicon-based core 10 on the cross-sectional view are silicon microcrystals 101, and the white areas are SiOₓ 102; the black particles in the silicon-based core 10 in the cross-sectional view are collected through software, and the ratio of the area of the black particles in the silicon-based core 10 to the area of the silicon-based core 10 was calculated; 5-10 silicon-based anode materials are randomly selected and cut to obtain their cross-sections, the ratio of the total area of the silicon microcrystals 101I to the area of the silicon-based core 10 was calculated respectively, and the average value of the ratios was taken as the ratio of the total area of the silicon microcrystals 101 to the area of the silicon-based core 10.

In an embodiment, the silicon microcrystals 101 are dispersed in a SiOₓ 102 substrate to form a silicon-based core 10, and the SiOₓ 102 substrate includes SiO₂ and amorphous silicon. In the embodiment, the SiO₂ in the silicon-based core 10 can increase the resistance of lithium intercalation, thereby reducing the potential for the first-cycle lithium intercalation. During the first-cycle lithium intercalation, the SiOₓ in the silicon-based core 10 will react with lithium ions in the electrolyte to form Li₂O, silicon-lithium alloy, and Li₄SiO₄, the silicon-lithium alloy and Li₄SiO₄ have a reversible capacity, which can improve the initial coulombic efficiency during charging and discharging of the silicon-based anode material. Also, in the subsequent charging and discharging process, Li₂O and Li₄SiO₄ can inhibit the volume change of the silicon microcrystals 101 and improve the cycle stability of the silicon-based anode material. In an embodiment, the mass ratio of silicon microcrystals 101 to SiOₓ in the silicon-based core 10 is (1-15):100. By controlling the mass ratio, a high charge-discharge capacity of the silicon-based anode material can be ensured, and the volume expansion of the silicon microcrystals 101 can be inhibited, thereby ensuring the structural stability of the silicon-based anode material. In an embodiment, the value of x in SiOₓ is 0.9≤x≤1.3. Further, the value of x may be, but not limited to, 0.9, 0.95, 1, 1.05, 1.1, 1.13, 1.2, 1.26, or 1.3. In an embodiment, the median particle size D50 of SiOₓ is 0.5 μm-15 μm, further 1 μm-10 μm, specifically but not limited to 0.5 μm, 1 μm, 2 μm, 5 μm, 8 μm, or 10 μm. Controlling the median particle size of the SiOₓ can not only promote a fast transmission of lithium ions to ensure the charge-discharge capacity of the secondary battery, such as the lithium-ion battery, but also reduce the interface oxidation effect of SiOₓ and achieve an excellent initial coulombic efficiency and capacity performance of the secondary battery, such as the lithium-ion battery. In an embodiment, in SiOₓ, D10/D50≥0.3, and D90/D50≤2. The median particle size D50 of the silicon-based core 10 is that 0.5 μm≤D50≤15 μm, D10/D50≥0.3, and D90/D50≤2. By optionally controlling a narrow distribution of the particle size of SiOₓ, excellent cycling performance and low expansion effect of the silicon-based anode material can be achieved.

The shell layer 20 of the silicon-based anode material is arranged on the silicon-based core 10. By arranging the shell layer 20 on the surface of the silicon-based core 10, the volume expansion and shrinkage effect of SiOₓ 102 and silicon microcrystals 101 during the intercalation and extraction of lithium can be suppressed, thus improving the electrochemical performance of silicon-based anode material, in some embodiments, as shown in FIGS. 1-9, the shell layer 20 includes a carbon layer 201. The carbon layer 201 is coated on the surface of the silicon-based core 10. The carbon layer 201 is not only electrically conductive, but also acts as a buffer structure. In an embodiment, the carbon layer 201 is an amorphous carbon layer. In an embodiment, the thickness of the carbon layer 201 is 0.5 nm-100 nm. Further, the thickness of the carbon layer 201 may be 1 nm-20 nm, specifically, but not limited to, 1 nm, 3 nm, 5 nm, 8 nm, 10 nm, 15 nm, 20 nm, 40 nm, 60 nm, or 100 nm. An appropriate thickness of the carbon layer 201 coated on the surface of the silicon-based core 10 can inhibit the volume expansion effect of the silicon microcrystals 101, without affecting the intercalation and extraction of lithium, thereby enhancing the specific capacity of the silicon oxides anode material. In the embodiment, the thickness of the layer structures such as the carbon layer 201 is controlled, so that the carbon content in the shell layer 20 accounts for 1 wt %-15 wt % of the entire silicon-based anode material. By controlling the carbon content in the shell layer 20, good conductivity of the shell layer 20 can be ensured, thus allowing the silicon-based anode material to have a higher capacity.

In other embodiments, as shown in FIGS. 2, 4, and 6-9, the shell layer 20 further includes a polymer layer 202 coated on the surface of the carbon layer 201. The polymer layer 202 has a certain mechanical strength, therefore, the polymer layer 202 on the surface of the carbon layer 201, on the one hand, can prevent the carbon layer 201 from falling off, so as to inhibit the volume change of the silicon-based anode material during charging and discharging and improve the structural stability; on the other hand, the polymer layer 202 can prevent the electrode material from directly contacting the electrolyte to form an excessive amount of SEI (solid electrolyte interphase) film, thereby lowering the lithium loss and effectively reducing loss of battery capacity. In the embodiments, the mass of the polymer layer 202 accounts for 1%-20% of the total mass of the silicon-based anode material. An appropriate content of the polymer layer 202 can provide sufficient structural strength to maintain the structural stability of the silicon-based anode material during charging and discharging, thereby improving the cycle life of the battery.

In an embodiment, the polymer layer 202 includes a polymer. In a specific embodiment, the polymer includes at least one of polyvinylidene fluoride with the structure of [CH₂—CF₂]ₙ—, sodium alginate with the structure of (C₆H₇O₆Na)ₙ, sodium carboxymethyl cellulose with the structure of [C₆H₇O₂(OH)₂OCH₂COONa]ₙ, polyacrylic acid with the structure of [C₃H₄O₂]ₙ, polyacrylate with the structure of [C₃H₃O₂M]ₙ (M=alkali metal salt), polyacrylonitrile with the structure of (C₃H₃N)ₙ, polyamide having amide bond (—NHCO—), polyimide containing imide ring (—CO—N—CO—) in the main chain, polyvinylpyrrolidone (PVP), and the like. In an embodiment, the mass content of the polymer in the silicon-based anode material is 0.1 wt %-5 wt %.

In some embodiments, the polymer layer 202 further includes a conductive agent. Adding the conductive agent to the polymer layer 202 can enhance the conductivity of the polymer layer and increase the conductivity of the silicon-based anode material. In an embodiment, the conductive agent includes at least one of carbon black, graphite, mesocarbon microspheres, carbon nanofibers, carbon nanotubes, C60, and graphene. In an embodiment, the mass of the conductive agent accounts for 0.5 wt %-10 wt % of the total mass of the silicon-based anode material. In an embodiment, the mass ratio of the conductive agent to the polymer in the polymer layer is (0.5-5):1, further, the mass ratio of the conductive agent to the polymer in the polymer layer is (1-3):1. When the mass ratio between the conductive agent and the polymer are within the above range, the polymer layer can completely cover the carbon layer, which enhances the structural stability of the silicon-based anode material, and the polymer layer has good conductivity, so that the reversible capacity of secondary batteries such as lithium-ion batteries can be ensured.

In addition to the carbon layer 201, or further, the polymer layer 202, the shell layer 20 of silicon oxide anode material of the above-mentioned embodiments further includes a transition layer. The transition layer is coated on the silicon-based core 10, and the carbon layer 201 is coated on the transition layer. The transition layer contains at least one element of lithium, magnesium, and sodium. By providing the transition layer in the shell layer 20, a synergistic effect with the carbon layer 201 or further with the polymer layer 202 can be achieved, and the coverage of the shell layer 20 on the silicon-based core 10 can be improved, so that the silicon-based anode material has a relatively higher initial coulombic efficiency, low internal resistance, etc., and the shell layer 20 has high mechanical properties, effectively inhibits the volume expansion of the silicon-based anode material, and improves the cycle performance.

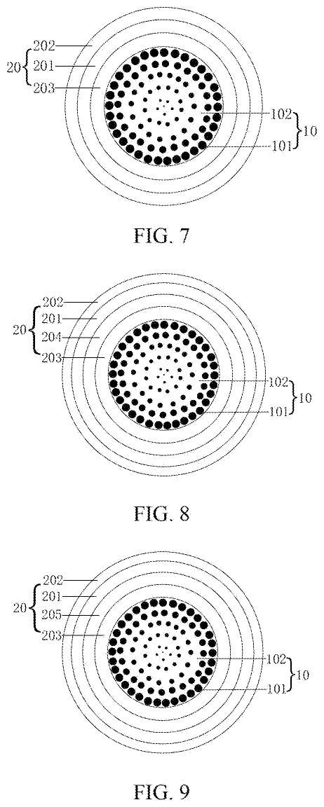

In some embodiments, as shown in FIGS. 7 to 9, the transition layer includes any one of a pre-lithiation layer 203, a magnesium-containing layer 204, a silicon carbide-containing layer 205, a composite layer of the pre-lithiation layer 203 and the magnesium-containing layer 204, and a composite layer of the pre-lithiation layer 203 and the silicon carbide-containing layer 205.

In some embodiments, when the transition layer includes a pre-lithiation layer 203, the pre-lithiation layer 203 is coated on the silicon-based core 10, and the carbon layer 201 is coated on the pre-lithiation layer 203, as shown in FIGS. 7 to 9; when the transition layer includes a magnesium-containing layer 204, the magnesium-containing layer 204 is coated on the silicon-based core 10, and the carbon layer 201 is coated on the magnesium-containing layer 204 (the magnesium-containing layer 204 directly coated on the silicon-based core 10 is not shown in the figures); when the transition layer includes a silicon carbide-containing layer 205, the silicon carbide-containing layer 205 is coated on the silicon-based core 10, and the carbon layer 201 is coated on the silicon carbide-containing layer 205 (the silicon carbide-containing layer 205 directly coated on the silicon-based core 10 is not shown in the figure); when the transition layer includes a composite layer of the pre-lithiation layer 203 and the magnesium-containing layer 204, the pre-lithiation layer 203 is coated on the silicon-based core 10, the magnesium-containing layer 204 is coated on the pre-lithiation layer 203, and the carbon layer 201 is coated on the magnesium-containing layer 204, as shown in FIG. 8; when the transition layer includes a composite layer of the pre-lithiation layer 203 and the silicon carbide-containing layer 205, the pre-lithiation layer 203 is coated on the silicon-based core 10, the silicon carbide-containing layer 205 is coated on the pre-lithiation layer 203, and the carbon layer 201 is coated on the silicon carbide-containing layer 205, as shown in FIG. 9.

Providing the pre-lithiation layer 203 in shell layer 20 can enable the silicon-based anode material, while having a high capacity, to first consume the oxygen in silicon oxides, avoid reaction of oxygen and the lithium in the subsequent charging process, and keep the content of effective reversible lithium, also to achieve lithium supplementation, so as to improve the initial coulombic efficiency of the silicon-based anode material. At the same time, the pre-lithiation layer 203 and other layers in the shell layer 20 have a synergistic effect, which improves the mechanical properties of the shell layer 20 and the cycle stability of the silicon-based anode material. The pre-lithiation layer 203 includes a pre-lithiation material. For example, in an embodiment, the pre-lithiation material includes at least one of Li₂SiO₃, Li₄SiO₄, and Li₂SiO₅. The pre-lithiation material can pre-modify the destabilized SiO₂ component into another lithium silicate during charging and discharging of the battery, thereby reducing irreversible capacity loss and improving the initial coulombic efficiency. In one embodiment, the thickness of the pre-lithiation layer 203 is 50 nm-5 μm, preferably 50 nm-2000 nm. By optimizing the thickness of the pre-lithiation layer 203, not only the silicon-based core 10 can be effectively coated, but also abundant lithium and silicon can be provided, the capacity of the silicon-based anode material can be improved, and the effect of lithium supplement on the anode can be optimized.

The magnesium-containing layer 204 in the shell layer 20 can have a synergistic effect with other layers in the shell layer 20. On the one hand, the safety performance of silicon-based anode material can be ensured, prevent fires and breakage of batteries containing the silicon-based anode material; on the other hand, the magnesium element can consume the oxygen in the silicon oxide in advance, avoid the reaction between the oxygen and the lithium in the later charging process, maintain the effective reversible lithium content, and at the same time reduce the surface activity of the silicon-based anode material to inhibit the decomposition of the electrolyte, thereby improving the cycling performances; in a third aspect, the mechanical properties of the shell layer 20 can be improved, which effectively inhibits the volume expansion of the silicon-based anode material, thereby significantly enhancing the structural stability and cycling performance of the silicon-based anode material during charge and discharge.

In an embodiment, the magnesium-containing layer 204 contains a microporous structure (not shown in FIG. 8) distributed therein, in the embodiment, the measured aperture of the pores in the microporous structure is 10 nm-500 nm, the spacing between two adjacent pores is 10 nm-500 nm. By controlling and optimizing the pore size and pore distribution of the magnesium-containing layer 204, the silicon-based core 10 is provided with sufficient space for expansion, this is beneficial to reduce the volume expansion effect of the silicon-based anode material and improve the cycling performance. The pore structure is not communicated, that is, the pores contained in the microporous structure are preferably non-through pores, which can prevent the electrolyte from penetrating into the silicon core and causing side reactions, and improve its cycling performance.

In an embodiment, the pores of the microporous structure in the magnesium-containing layer 204 are distributed along a direction from the silicon-based core 10 to the outer carbon layer 201, and the diameter of the pores gradually increases along the above direction. This can effectively alleviate the expansion of the silicon-based core 10 during charging and discharging, and effectively reduce the stress generated by the expansion, thereby avoiding the breakage of the silicon-based core 10 during the cycles and improving the cycling performance. At the same time, the porous structure provides a channel for the migration of lithium ions, which improves the migration rate of the lithium ions.

The material of the magnesium-containing layer 204 includes magnesium element. In the embodiment, the material of the magnesium-containing layer 204 is a Mg—Si—O system. By providing the microporous structure in the magnesium-containing layer 204, and controlling and optimizing the material thereof, the surface activity of the silicon-based anode material can be lowered, so as to inhibit the decomposition of the electrolyte and improve the stability of the electrolyte, thereby improving the cycling performances. In addition, the magnesium-containing layer 204 contains magnesium element, so that the safety performance of batteries can be ensured, preventing adverse phenomena like fires and breakage of the batteries.

In an embodiment, the material of the magnesium-containing layer 204 includes at least one of magnesium oxides, Mg₂SiO₄, MgSiO₃, magnesium hydroxides, and magnesium alloys, Magnesium oxides or magnesium alloys may also be doped with elements such as silicon, aluminum, titanium, and the like. By further selecting the material of the magnesium-containing layer 204, the surface activity of the silicon-based anode material can be improved, and the stability of the electrolyte and the safety of the battery can be improved.

In an embodiment, the thickness of the above-mentioned magnesium-containing layer 204 is 50 nm-5 μm, and/or the percentage of the weight of the magnesium-containing layer 204 to the weight of the silicon-based core 10 of the silicon-based material is greater than 0, less than or equal to 30 wt %. By controlling and optimizing the thickness of the magnesium-containing layer 204 and the weight ratio relative to the silicon-based core 10, the above-mentioned functions of the magnesium-containing layer 204 are further enhanced, thereby improving cycle stability and safety.

The silicon carbide-containing layer 205 is provided in the shell layer 20. Adding the silicon carbide 205 in shell layer 20 results in a synergistic effect with carbon layer 201, which can effectively improve the bonding strength of the carbon layer 201 on the silicon-based inner core 10, so as to effectively resist the violent volume expansion and contraction of the battery during charging and discharging, and reduce the risk of falling off of the shell layer 20 such as the carbon layer 201. In an embodiment, the thickness of the silicon carbide-containing layer 205 is preferably uniform and dense, so as to more effectively improve the strength of the carbon layer 201. In some embodiments, the silicon carbide-containing layer 205 has a thickness of 0.5 nm-3 nm. The thickness of the silicon carbide-containing layer 205 within this range can effectively improve the bonding strength of the shell layer 20 and improve the fixing of the carbon layer 201.

In an embodiment, the BET specific surface area of the silicon-based anode material is 1 m²/g-10 m²/g, further, the BET specific surface area of the silicon-based anode material is 2 m²/g-8 m²/g.

Therefore, the silicon-based anode material in the above-mentioned embodiments uses the silicon-based anode containing SiOₓ 102 and the silicon microcrystals 101 as the silicon-based core 10, so that the silicon-based anode material has a higher capacity. Employing the shell layer 20 in the above embodiments can effectively cover the silicon-based core 10 and inhibits the volume expansion of the silicon-based material during charging and discharging. The layers in the shell layer 20 also have a synergistic effect, which not only reduces the surface activity of the silicon-based anode material and inhibits the decomposition of the electrolyte, thereby improving the stability of the electrolyte, but also, enhances the mechanical properties of the shell layer 20 and effectively inhibits the volume expansion of the silicon-based anode material, thereby significantly enhancing the structural stability and cycling performance of the silicon-based anode material during charge and discharge. At the same time, adverse effects such as fires and breakage of the battery can also be hindered. After testing, the specific capacity of the silicon-based anode material can reach 1200 mAh/g-1700 mAh/g. The initial coulombic efficiency is above 73%, and the retention rate after 100 cycles is over 87%, exhibiting high capacity and excellent cycling performance.

Accordingly, an embodiment of the present application also provides a preparation method for the above-mentioned silicon-based anode material, which includes the following steps:
In S01: a dynamic heat treatment is carried out on silicon monoxide to obtain a silicon-based core; and
In S02: forming a shell layer including a carbon layer on the silicon-based core to obtain the silicon-based anode material.

In step S01, the silicon-based core obtained after the dynamic heat treatment is the silicon-based core 10 in the above-mentioned silicon-based anode material. Therefore, the silicon-based core obtained through the dynamic heat treatment in step S01 is as described above in the silicon-based core 10 of the silicon-based anode material, and the components in the silicon-based core obtained in step S01 are not repeated herein.

In an embodiment, the dynamic heat treatment in step S01 is specifically as follows: placing silicon monoxide in a heat treatment furnace under the protection of a non-oxidizing atmosphere, and making the silicon monoxide flow in the heat treatment furnace by stirring, fluidizing, rotating, and the like, the heating temperature is 800° C.-1300° C., further 800° C.-1200° C., further 1000° C.-1100° C., and the heating duration is 1 hr-6 hrs. In other embodiments, the heating temperature is 850° C.-1050° C., and the heating duration is 2 hrs-5 hrs. In an embodiment, the equipment for the dynamic heat treatment may be any one of a rotary furnace, a chamber furnace, a tube furnace, a roller kiln, a pusher kiln, or a fluidized bed. By adopting a dynamic heat treatment, the silicon monoxide can be evenly heated, thereby obtaining a distribution structure in which the distribution density of silicon microcrystals gradually decreases along the direction from the surface layer of the silicon-based core to the center of the silicon-based core. In an embodiment, the particle size of silicon monoxide is 1 μm-10 μm, specifically, but not limited to, 1 μm, 3 μm, 5 μm, 7 μm, and 10 μm. By controlling the particle size of the silicon monoxide, the size of the silicon microcrystals in the silicon-based core obtained through the reaction is appropriate, thereby slowing down the volume expansion effect of the silicon microcrystals. In the embodiment, silicon monoxide can undergo disproportionation reaction under a high temperature to generate silicon dioxide and silicon; silicon includes amorphous silicon and silicon microcrystals; silicon dioxide is amorphous silicon dioxide, and the structure of silicon dioxide is strong, so as to alleviate the volume change of silicon during intercalation and extraction of lithium. In the embodiment, during the dynamic heating of silicon monoxide, since the heat is transferred inwardly from the surface of the silicon-based anode material, the heat gradually decreases along the direction from the surface layer of the silicon-based core to the center of the silicon-based core, thus the amount of silicon monoxide undergoing disproportionation reaction also gradually decreases. Under certain duration and temperature conditions, the silicon monoxide on the surface of the silicon-based core fully reacts to form more silicon microcrystals, and the number of silicon microcrystals formed under the surface of the silicon-based core gradually decreases, so that the silicon-based core has distribution structure in which the distribution density of silicon microcrystals gradually decreases along the direction from the surface layer of the silicon-based core to the center of the silicon-based core.

In step S02, the shell layer formed on the silicon-based core is the shell layer 20 of the silicon-based anode material above, and the carbon layer of the shell layer formed is the carbon layer 201 in the shell layer 20 of the silicon-based anode material mentioned above. Moreover, the method for forming the shell layer on the silicon-based core can be a corresponding method according to the layer structure contained in the shell layer. In the embodiment, when the shell layer is a carbon layer, the carbon layer, namely the carbon layer 201 in the shell layer 20 of the above silicon-based anode material, can be prepared by any one of solid-phase coating, liquid-phase coating or gaseous-phase coating. In some embodiments, the carbon layer is coated on the surface of the silicon-based core by chemical vapor deposition, wherein the temperature of the vapor deposition process is 700° C.-1300° C., and the deposition time is 0.5 hr-4 hrs. In some other embodiments, the carbon layer is coated on the surface of the silicon-based core by an in-situ carbonization method. In the embodiments, the carbon source used for coating the carbon layer can be one or more of C₁-C₄ alkanes, alkenes, alkynes, pitch, glucose, sucrose, starch, citric acid, ascorbic acid, and polyethylene glycol. In the embodiments, the atmosphere during the coating process of the carbon layer is a non-oxidizing atmosphere. Further, the non-oxidizing atmosphere can be one or more of nitrogen, helium, argon, and hydrogen. In the embodiments, the equipment for coating the carbon layer is any one of a rotary furnace, a chamber furnace, a roller kiln, a pusher kiln, or a fluidized bed.

In an embodiment, before forming the shell layer on the silicon-based core in the above-mentioned steps S02, the method further includes forming a transition layer on the silicon-based core obtained in step S01, and the transition layer contains at least one element of lithium, magnesium, and sodium. Since the transition layer is formed on the silicon-based core obtained in step S01, the transition layer should be formed on the silicon-based core, such as covering the silicon-based core. In an embodiment, the transition layer is the transition layer of the shell layer 20 of the above silicon-based anode material, then the transition layer includes any one of the pre-lithiation layer 203, the magnesium-containing layer 204, the silicon carbide-containing layer 205, the composite layer of the pre-lithiation layer 203 and the magnesium-containing layer 204, and the composite layer of the pre-lithiation layer 203 and the silicon carbide-containing layer 205 of the shell layer 20 of the above silicon-based anode material.

In an embodiment, the method for forming the pre-lithiation layer 203 includes the following steps:
immersing the silicon-based core into an electrolyte containing a lithium salt, constructing a primary battery with the electrolyte and the electrode, so that a reduction reaction occurs in the electrolyte to generate a pre-lithiation material layer on the silicon-based core.

By constructing the primary cell system to directly react, the pre-lithiation layer 203 containing the pre-lithiation material is directly formed in situ on the surface of the silicon-based core to coat the silicon-based core. On the one hand, energy consumption is effectively reduced, and the reaction conditions are mild and controllable, so as to effectively overcome the shortcomings of high energy consumption and uncontrollable stability and reliability in the existing methods of using lithium source and/organic compound for high temperature (such as 160° C.-250° C.) thermal reaction to generate organic pre-lithiation materials. On the other hand, a pre-lithiation layer containing a pre-lithiation material is generated through a direct oxidation-reduction reaction between the silicon-based core and the lithium ions in the electrolyte, which effectively enhances the compactness of the pre-lithiation layer. In addition, it is also possible to flexibly control the reaction time to control the thickness of the pre-lithiation layer. In a specific embodiment, the constructed primary battery system includes a conductive metal container, an electrolyte contained in the conductive metal container, and a lithium metal first electrode and a lithium metal second electrode at least inserted in the electrolyte, the first electrode and the second electrode are attached to the inner wall of the conductive metal container respectively, and the silicon-based core is immersed in the electrolyte and disposed close to one end of the lithium metal.

In an embodiment, the reaction of the primary battery further includes a stirring treatment, so that the redox reaction can take place relatively uniformly in the electrolyte and improve the homogeneity of pre-composite silicon-based anode material. In one embodiment, the stirring rate is preferably 500 rpm-2000 rpm.

The electrolyte includes a solvent, a lithium salt dissolved in the solvent, and silicon-based cores dispersed in the solvent. Therefore, the silicon-based cores in the electrolyte can be short-circuited with the conductive part of the primary battery system. Since the potential difference between silicon oxide (greater than 0.4 V) and lithium (0 V) is different, a primary battery is formed, so that the silicon-based cores react with lithium ions and deposit. Specifically, the redox reaction in the above-mentioned primary battery system includes the following:

Li⁺+e⁻+SiOₓ→Li₂SiO₃,Li₄SiO₄,Li₂SiO₅

Certainly, when the contained electrodes of the primary battery system are lithium sheets, the lithium sheets may also participate in the reaction to keep lithium ions balanced in the electrolyte. Therefore, in the primary battery system, the lithium ions contained in the electrolyte and the SiOₓ on the surface of the silicon-based core undergo the above-mentioned redox reaction, so that a pre-lithiation material containing any one or more of Li₂SiO₃, LiSiO₄, Li₂SiO₅, etc. is formed on the SiOₓ surface in situ, and is coated on the surface of the silicon-based core to form a core-shell structure, in which the unreacted SiOₓ constitutes the core body, namely the silicon-based core 10 in the above-mentioned silicon-based anode material, and the in-situ generated pre-lithiation layer formed by the pre-lithiation material constitutes the pre-lithiation layer 203 in the shell layer 20 of the above silicon-based anode material. Therefore, the reaction system of the primary battery system effectively reduces energy consumption, and the reaction conditions are mild and controllable, which effectively reduces energy consumption. Moreover, the reaction can be carried out simultaneously on the entire surface of the silicon-based core, thereby effectively improving the compactness of the generated pre-lithiation layer, and the efficiency is high.

In another embodiment, the method for forming pre-lithiation layer 203 includes the following steps:
immersing the silicon-based core in the electrolyte containing a lithium salt, and electrolyzing the electrolyte so that a reduction reaction occurs in the electrolyte to generate a layer containing a pre-lithiation material on the silicon-based core.

By directly carrying out electrolytic treatment to the electrolyte containing lithium ions and silicon-based core, and forming in situ the pre-lithiation layer containing the pre-lithiation material on the surface of the silicon-based core in the electrolyte, as discussed in the above-mentioned primary battery system, on the one hand, the energy consumption is effectively reduced, and the reaction conditions are mild and controllable, so as to effectively overcome the high energy consumption and uncontrollable stability and reliability in the existing method using lithium source and/organic compound for high temperature (such as 160° C.-250° C.) thermal reaction to generate organic pre-lithiation materials. On the other hand, by forming the pre-lithiation layer through the direct redox reaction between the silicon-based core and the lithium ions in the electrolyte, the compactness of the pre-lithiation layer is effectively improved, and the binding strength between the pre-lithiation layer and the silicon-based core is enhanced. In addition, it is also possible to flexibly control the reaction time so as to control the thickness of the pre-lithiation layer.

The above-mentioned electrolytic treatment system may be designed according to existing electrolytic system. In a specific embodiment, the electrolytic system includes a conductive metal container, the electrolyte in the conductive metal container and a lithium metal first electrode and a lithium metal second electrode that are at least inserted in electrolyte, and the first electrode and the second electrode are respectively connected to the positive and negative terminals of the power supply and immersed in the electrolyte; the silicon-based core is immersed in the electrolyte, and is close to an end of the lithium metal. In one embodiment, in the electrolytic treatment system, the voltage of the electrolytic treatment is 0.01 V-1 V, and the current density is 0.1 mAh/cm²-5 mAh/cm². Under this voltage, the time of electrolytic treatment may be, but not limited to, 15 min-60 min. In a specific embodiment, the electrodes in the electrolytic treatment system may be two lithium metal sheets. In the embodiment, the electrolytic treatment process also includes a stirring treatment, so that a more uniform electrolytic treatment can be performed in the electrolyte, and the uniformity of the pre-composite silicon-based anode material can be improved. In one embodiment, the stirring rate is preferably 500 rpm-2000 rpm.

Since the electrolyte includes a solvent and a lithium salt dissolved in the solvent and a silicon-based core dispersed in the solvent. Therefore, the redox reaction in the above-mentioned electrolytic treatment system includes the following:

Li⁺+e⁻+SiOₓ→Li₂SiO₃,Li₄SiO₄,Li₂SiO₅

Certainly, when the electrodes in the electrolytic treatment system are lithium sheets, the lithium sheets may also participate in reaction, to keep the balance of lithium ions in electrolyte. Therefore, in the electrolytic treatment system, the lithium ions and the SiOₓ on the surface of the silicon-based core contained in the electrolyte undergo the above-mentioned redox reaction, so that a pre-lithiation material containing any one or more of Li₂SiO₃, Li₄SiO₄, Li₂SiO₅, etc. is formed on the SiOₓ surface in situ, and is coated on the surface of the silicon-based core to form a core-shell structure, thus the in-situ generated pre-lithiation material forms the pre-lithiation layer. Therefore, the reaction system of the primary battery system effectively reduces energy consumption, and the reaction conditions are mild and controllable, which effectively reduces energy consumption. Moreover, the reaction can be carried out simultaneously on the entire surface of the silicon-based core, thereby effectively improving the compactness of the generated pre-lithiation layer, and the efficiency is high.

In one embodiment, the mass ratio of the solvent to the lithium salt contained in the above-mentioned electrolyte is (0.1-98):(0.001-15). For example, the concentration of the electrolyte and the lithium salt in the electrolyte solution are preferably 0.1 mol/L-10 mol/L. In a specific embodiment, the lithium salt includes at least one of lithium hexafluorophosphate, lithium aluminum tetrachloride, lithium trifluoroformate, lithium borate, lithium hexafluoroarsenate, lithium perchlorate, lithium nitrate, lithium sulfate, lithium hydroxide, lithium oxide, lithium fluoride, lithium oxalate/lithium acetate, and lithium formate. The solvent contained in the electrolyte includes at least one of ethylene carbonate, dimethyl carbonate, ethyl methyl carbonate, diethyl carbonate, dimethyl maleate, tetrahydrofuran, and methyl carbonate. Through the selection of components such as the electrolyte and the concentration of the electrolyte, the lithium salt, and the solvent, the redox reaction in the above-mentioned primary battery system or electrolytic treatment system can be optimized, the efficiency of the redox reaction can be improved, at the same time the formation rate and compactness of the coating layer formed by the pre-lithiation material and uniformity of the core-shell structure can be improved.

In another embodiment, the method for forming the pre-lithiation layer 203 includes the steps:
a solution of precursor of the pre-lithiation material is coated on the silicon-based core, and then sintered to generate a layer containing the pre-lithiation material on the silicon-based core, the precursor of the pre-lithiation material should be the precursor of the pre-lithiation material forming the above pre-lithiation layer 203. The solution of the precursor of the pre-lithiation material is pre-coated on the silicon-based core, and then sintered to form the pre-lithiation layer.

In another embodiment, the method for forming the pre-lithiation layer 203 includes the steps:
the precursor of a pre-lithiation material is deposited on the silicon-based core through chemical vapor deposition and a reduction reaction occurs, so that a layer containing the pre-lithiation material is generated on the silicon-based core.

The process condition of the chemical vapor deposition treatment may be a conventional process of chemical vapor deposition, such as depositing a pre-lithiation layer by atomic layer deposition. Regardless of which chemical vapor deposition method is used to prepare the pre-lithiation layer, the chemical vapor deposition may be performed to undergo a deposition reaction according to an existing process to form the pre-lithiation layer. The material of the pre-lithiation layer is a precursor for forming the pre-lithiation material.

In another embodiment, the method for forming the pre-lithiation layer 203 includes the steps:

The material of the pre-lithiation layer is subjected to physical vapor deposition to generate a layer containing the pre-lithiation material on the silicon-based core.

The process condition of the physical vapor deposition process may be a conventional process of physical vapor deposition, such as forming a pre-lithiation layer by magnetron sputtering. Regardless of which physical vapor deposition method is used to prepare the pre-lithiation layer, the physical vapor deposition method may be performed according to the existing process to form the pre-lithiation layer. The material of the pre-lithiation layer is the pre-lithiation material of the above-mentioned pre-lithiation layer.

In an embodiment, the method for forming the magnesium-containing layer 204 includes the following steps:
a. powder of the magnesium-containing material is mixed with the silicon-based core to form a mixture containing silicon and magnesium;
b. the mixture is sintered to form a magnesium-containing coating layer on the silicon-based core to obtain the first coated silicon-based particle material; the temperature of the sintering treatment is the temperature at which the silicon-based core reacts with magnesium;
c. the carbon-containing layer is formed on the surface of the first coated silicon-based particle material to obtain a second coated silicon-based particle material;
d. The second coated silicon-based particle material is subjected to acid-pickling, and the magnesium-containing coating layer is etched to form a microporous structure, so that the magnesium-containing layer is formed.

In step a, the purpose of mixing the silicon-based core and the magnesium-containing powder is to evenly mix the silicon-based core and the magnesium-containing powder, thereby improving the uniformity of the magnesium-containing layer in step b.

In an embodiment, the method for obtaining a mixture containing silicon and magnesium in step a includes:

The silicon-based core and powder of the magnesium-containing material are mixed into a mixed suspension, and then the mixed suspension is spray-dried to obtain the silicon- and magnesium-containing mixture.

By spray drying, the silicon-based core and the powder of the magnesium-containing material can be mixed evenly, and a uniform particle structure can be formed. The mixed suspension, for example, the concentration and particle size in the suspension, etc., should meet the requirements of spray drying. In an embodiment, the mass ratio of the powder of the magnesium-containing material to the silicon-based core is 1:(2-10). By controlling and optimizing the mixing ratio and particle size of the silicon-based core and the powder of the magnesium-containing material in step a, it is possible that in the mixture containing silicon and magnesium formed, such as by spray drying, in step a, the powder of the magnesium-containing material can be coated on the surface of the silicon-based core beforehand, thereby improving the uniformity of the magnesium-containing coating layer in step a. Moreover, the thickness of the coating layer can be controlled and adjusted by adjusting the mass ratio of the powder of the magnesium-containing material to the silicon-based core. In a specific embodiment, the magnesium-containing material includes at least one of elemental magnesium and magnesium alloys; the magnesium alloys contain at least one element of silicon, aluminum, and titanium, that is, the magnesium alloy may be an alloy or composite magnesium oxide formed by magnesium element and at least one of silicon, aluminum, and titanium.

In step b, a chemical reaction occurs at the interface between the magnesium-containing material and the silicon-based core during the sintering of the mixture. Magnesium-containing materials such as elemental magnesium or/and magnesium alloy can reduce silicon oxide and release a large amount of heat, which in turn can reduce the disproportionation temperature of SiOₓ, increase the degree of disproportionation of SiOₓ, and effectively reduce the temperature of sintering treatment. According to the inventor's research and testing, the products produced by the reaction between the two mainly include at least one of magnesium oxide, magnesium silicate (MgSiO₃) and magnesium orthosilicate (Mg₂SiO₄), magnesium hydroxides, magnesium alloys, etc.

Part of the chemical reaction formulae in the sintering process is as follows:

SiO₂(s)+Mg(g)→MgO(s)+Si(s);

SiO₂(s)+Mg(g)′Mg₂SiO₄(s)+Si(s);

SiO₂(s)+Mg(g)→MgSiO₃(s)+Si(s);

These reaction products constitute the material of the magnesium-containing coating layer in step b, based on the reaction in the above-mentioned sintering treatment, the sintering treatment is carried out under a protective atmosphere. Hydrogen is preferred, and the concentration of hydrogen is 10 ppm-1000 ppm, which can improve cycle performance.

Based on the effect and products of the above-mentioned sintering treatment, the temperature of the sintering treatment is such that a redox reaction can take place between the silicon-based core and magnesium. In some embodiments, the sintering treatment is 400° C.-1200° C., and further is 600° C.-1200° C. It should be understood that the duration for this sintering treatment should be sufficient. At the same time, the magnesium-containing material can lower the disproportionation reaction temperature of the silicon-containing material, reduce energy consumption, and save production costs.

In step c, after the carbon-containing layer is formed on the surface of the first coated silicon-based particle material, the carbon-containing layer constitutes the carbon layer 201 in the shell layer 20 of the above-mentioned silicon-based anode material and is coated on the magnesium-containing coating layer in step b. The method for forming a carbon-containing layer on the surface of the first coated silicon-based particle material may be any method capable of forming a carbon layer, such as vapor deposition (physical vapor deposition or chemical vapor deposition), carbonization after coating with carbon-source-containing solution, and the like.

In an embodiment, the carbon-containing layer is formed on the surface of the first coated silicon-based particle material by a gaseous phase method, and the method may further include the following steps:

After the sintering treatment in step b, a heat preservation treatment is carried out, and then a gaseous carbon source is introduced into the sintering treatment for cracking treatment, and a carbon-containing layer is directly formed on the surface of the first coated silicon-based particle material.

Forming the coating layer formed by the gaseous phase method has high efficiency, the bonding strength between the in-situ formed carbon-containing layer material and the surface of the first coated silicon-based particle material is high, and the uniformity and intactness of the coating layer formed are achieved.

In another embodiment, the carbon-containing layer may also be formed on the surface of the first coated silicon-based particle material through the following methods:

In one embodiment, the first coated silicon-based particle material is placed in a non-oxygen atmosphere, and an organic carbon source is used to undergo chemical vapor carbon deposition or in-situ carbonization to obtain a carbon-containing layer.

The organic carbon source may be one or more of C₁-C₄ alkanes, alkenes, and alkynes. The temperature of the chemical vapor carbon deposition or in-situ carbonization is 700° C.-1200° C. The above material is carbonized at high temperature to form a carbon layer, which is bound to the surface of the first coated silicon-based particle material.

In another embodiment, after mixing the organic carbon source with the first coated silicon-based particle material in the solid phase or liquid phase, a carbon-containing layer is formed on the surface of the first coated silicon-based particulate material through in-situ carbonization.

In step d, the second coated silicon-based particle material is subjected to a pickling treatment, so that the part of the magnesium-containing coating layer generated in step b that is in contact with the acid solution reacts with the acid and is removed partially or completely to generate a microporous structure, so that the magnesium-containing coating layer formed in step b eventually forms the above-mentioned magnesium-containing material 204 in the silicon-based anode material. Specifically, due to the existence of the carbon-containing layer in step c, which is coated on the surface of the magnesium-containing coating layer in step b, and because the carbon-containing layer contains carbon, therefore, the carbon-containing layer in step c is porous. During the pickling process of the second coated silicon-based particle material, the acid solution may etch the magnesium-containing coating layer through the porous structure of the carbon-containing layer, so that the part in contact with the acid solution reacts with the acid and is partially or completely removed. The inventors have found that after the pickling treatment in step c, the magnesium-containing coating layer is etched to form a rich microporous structure, thereby forming the above-mentioned magnesium-containing material layer 204 in the silicon-based anode material. Since the acid solution enters the surface of the magnesium-containing coating layer in step b from the pores contained in the porous structure of the carbon-containing layer in step c and gradually etches the magnesium-containing coating layer, therefore, in an embodiment, the magnesium-containing material layer 204 formed after pickling has a microporous structure, and the micropores are arranged along the direction from the silicon-based core 10 to the shell layer 20, and the diameter of the micropores gradually increases from the silicon-based core 10 to the shell layer 20.

In an embodiment, the pickling treatment of the second coated silicon-based particle material includes the following steps:

Immersing the second coated silicon-based particle material in an acid solution for soaking treatment. The acid in the acid solution should be an acid capable of reacting with the magnesium-containing coating layer material in step b, and may be an organic acid or an inorganic acid, such as sulfuric acid, hydrochloric acid, acetic acid, nitric acid, and the like. The concentration may be adjusted as required, for example, the concentration of the acid solution is 0.1 mol/L-10 mol/L.

In an embodiment, the method for forming the silicon carbide-containing layer 205 includes the following steps:

During the dynamic heat preservation process in an inert atmosphere and at a temperature of 700° C.-1300° C., the carbon source is introduced to continue the reaction, and the silicon carbide-containing layer and the carbon layer are formed on the surface of the silicon-based core;
alternatively,
a pyrolysis treatment is carried out on the carbon source under an inert atmosphere at 700° C.-1000° C., and a carbonized layer is formed on the silicon-based core; then the temperature is heated up to 1000° C.-1300° C. for a dynamic heat preservation treatment, such that reactions occur at the interface between the carbonized layer and the silicon-based core to form silicon carbide, thereby forming a silicon carbide-containing layer.

In the above embodiment, during the dynamic heat preservation, the carbon source forms a carbon material that reacts with the material on the surface of the silicon-based core to form silicon carbide, and then continues to grow on the surface of the silicon carbide-containing layer to form a carbon layer. During the disproportionation process, as the temperature increases, the degree of disproportionation increases. The higher the disproportionation, the higher the coulombic efficiency exhibited by the silicon-based core. However, excessive disproportionation will lead to large silicon microcrystals in size, and more amorphous silicon oxide associated with the silicon microcrystals, with an increase in silicon oxide compound that is not conducive to Li⁺ transport, thereby reducing the reversible capacity. In some embodiments, the temperature of the dynamic heat preservation treatment is 700° C.-1300° C., and the duration of the dynamic heat preservation is 0.5 hr-3 hrs. Therefore, after the silicon-based core is subjected to dynamic high-temperature treatment, the size distribution of the silicon microcrystals contained in the silicon-based core is further improved to have a gradient distribution, and SiC is effectively generated to form the above-mentioned silicon carbide-containing layer 205. In the above embodiments, the inert atmosphere includes, but not limited to, an argon atmosphere and nitrogen atmosphere.

In an embodiment, when the transition layer is a composite layer including a pre-lithiation layer 203 and a silicon carbide-containing layer 205, then the transition layer may be formed according to the formation of the above-mentioned pre-lithiation layer 203, where a pre-lithiation layer 203 is first formed on the silicon-based core, and then a silicon carbide-containing layer 205 is formed on the pre-lithiation layer 203.

As can be seen from the above, when the shell layer 20 contains a transition layer, and the transition layer includes a magnesium-containing layer 204 and a silicon carbide-containing layer 205, when preparing respectively the magnesium-containing layer 204 and the silicon carbide-containing layer 205 as described above, while forming the magnesium-containing layer 204 and the silicon carbide-containing layer 205, the carbon layer is also prepared simultaneously. In addition, when the shell layer 20 contains a transition layer, and the transition layer includes a pre-lithiation layer 203, a magnesium-containing layer 204, and a silicon carbide-containing layer 205, when preparing respectively the pre-lithiation layer 203, the magnesium-containing layer 204, and the silicon carbide-containing layer 205 as described above, the precursor material of the silicon-based core is also used together with the materials of the above layers, so that silicon-based cores, namely the above-mentioned silicon-based cores 10 in the silicon-based anode material, are formed simultaneously with the formation of the pre-lithiation layer 203, the magnesium-containing layer 204, and the silicon carbide-containing layer 205, so as to improve the preparation efficiency and structural stability of the silicon-based anode material.

In an embodiment, after forming the shell layer on the silicon-based core in the above-mentioned step S02, a polymer layer may also be prepared on the carbon layer, that is, the above-mentioned polymer layer 202 on the outer surface of the carbon layer 201 contained in the silicon-based anode material. In some embodiments, the preparation method of the polymer layer specifically includes: mixing the silicon-based core containing the carbon layer with a polymer solution, and drying to obtain the polymer layer. The polymer layer can be completely covered on the surface of the carbon layer by mixing with the solution, which aids in improving the structural stability of the silicon-based anode material. In an embodiment, the polymer solution includes a solvent and a polymer. In an embodiment, the solvent of the polymer solution is water. In some embodiments, the polymer solution includes a solvent, a conductive agent, and a polymer. When the polymer solution contains a conductive agent, the polymer can also show a binding effect, capable of being coated together with the conductive agent on the surface of the carbon layer to form a polymer layer. In an embodiment, the solid content of the polymer solution is 2 wt %-15 wt %, specifically but not limited to 2 wt %, 5 wt %, 10 wt %, 13 wt %, or 15 wt %. In some embodiments, the polymer includes one or more of polyvinylidene fluoride with the structure of [CH₂—CF₂]ₙ—, sodium alginate with the structure of (C₆H₇O₆Na)ₙ, sodium carboxymethyl cellulose with the structure of [C₆H₇O₂(OH)₂OCH₂COONa]ₙ, polyacrylic acid with the structure of [C₃H₄O₂]ₙ, salts of polyacrylic acid with the structure of [C₃H₃O₂M]ₙ (M=alkali metal salt), polyacrylonitrile with the structure of (C₃H₃N)ₙ, polyamide with amide bond (—NHCO—), polyimide with imide ring (—CO—N—CO—) in the main chain, polyvinylpyrrolidone (PVP), and the like. In some embodiments, the conductive agent includes one or more of carbon black, graphite, mesocarbon microspheres, carbon nanofibers, carbon nanotubes. C60, and graphene. In some embodiments, the mass ratio of the conductive agent to the polymer in the polymer solution is (0.5-5):1. Further, the mass ratio of the conductive agent to the polymer in the polymer solution is (1-3):1. In some embodiments, the drying method is spray drying.

In the preparation method for a silicon-based anode material according to the embodiment of the present application, the silicon-based cores with the distribution density thereof gradually decrease inwardly from the surface of the silicon-based cores is obtained by carrying out a dynamic heat treatment to silicon monoxide, and then the shell layer is coated on the silicon-based cores to form a silicon-based anode material. The preparation method has a simple process and is convenient to operate, and the obtained silicon-based anode material has a high yield rate, suitable for large-scale production.

In another aspect, an embodiment of the present application also provides an anode and a secondary battery containing the anode.

The anode is a silicon-based anode and includes a current collector and a silicon-based active layer bound on the surface of the current collector. The current collector in the anode includes any one of a copper foil and an aluminum foil. The silicon-based active layer includes an electrode active material, a binder and a conductive agent, the electrode active material includes the silicon-based anode material provided in the first aspect of the present application. In an embodiment, the binder includes one or more of polyvinylidene chloride, soluble polytetrafluoroethylene, styrene-butadiene rubber, hydroxypropyl methylcellulose, methylcellulose, carboxymethylcellulose, polyvinyl alcohol, acrylonitrile copolymer, sodium alginate, chitosan, and chitosan derivatives. In an embodiment, the conductive agent includes one or more of graphite, carbon black, acetylene black, graphene, carbon fibers, C60, and carbon nanotubes. In an embodiment, in the silicon-based active layer, the mass percentage of the silicon-based anode material is 70.0%-95.0%, the mass percentage of the conductive agent is 1.0%-15.0%, and the mass percentage of the binder is 2.0%-15.0%. In the embodiment, the preparation process of the anode is as follows: the silicon-based anode material, the conductive agent, and the binder are mixed to obtain an electrode slurry, the electrode slurry is coated on the current collector, and is dried, rolled, die-cut, etc. to obtain the anode. Since the anode contains the above-mentioned silicon-based anode material, the anode has a high capacity, stable cycling performance, and is not prone to adverse phenomena such as powdering and peeling.

The secondary battery includes a cathode, an anode, and a separator placed between the cathode and the anode, and also includes other necessary components of a secondary battery, such as an electrolyte. The anode is the anode in the embodiments of the present application. Therefore, the secondary battery has high capacity, initial coulombic efficiency, excellent cycling performance, long service life, and stable electrochemical performance. In an embodiment of the present application, the secondary battery includes a nickel-cadmium battery, a nickel-hydrogen battery, a lithium-ion battery, and a zinc-manganese battery.

In some embodiments, the secondary battery is a lithium-ion battery, and the lithium-ion battery includes the above-mentioned silicon-based anode material or the above-mentioned anode. In an embodiment, the lithium-ion battery has a reversible capacity of 1200 mAh/g-1600 mAh/g in a voltage window of 0.01 V-1.5 V, the first cycle efficiency is greater than or equal to 72%, and the capacity retention rate after 50 cycles is greater than or equal to 85%.

The application and preparation method of the silicon-based anode material according to embodiments of the present application are exemplified by the following examples.

### Example 1

The present example provides a silicon-based anode material, a preparation method therefor, and a lithium-ion battery.

The silicon-based anode material includes a silicon-based core and a shell layer arranged on the silicon-based core, and the silicon-based core includes SiOₓ and silicon microcrystals dispersed in the SiOₓ, where 0.9≤x≤1.3; and along a direction from the surface layer of the silicon-based core to the center of the silicon-based core, the distribution density of the silicon microcrystals gradually decreases; the shell layer includes a carbon layer and a polymer layer containing a mixture of a polymer and a conductive agent, and the carbon layer is coated on the silicon-based core.

The preparation method for the silicon-based anode material includes the following steps:

In step S1: 1 kg of silicon monoxide was placed in a rotary furnace with the introduction of an argon protective atmosphere, and heated up to 1050° C. at 5° C./min, then a dynamic heat preservation was carried out for 1.5 hrs in acetylene/argon mixed gas, a carbon layer was evenly coated on the surface of the material to obtain a silicon-based core containing the carbon layer. The carbon coating amount was measured to be 3.0% using a carbon/sulfur analyzer; and

In step S2: 100 g of the silicon-based core containing the carbon layer in the present example was added to 100 g of water-soluble conductive liquid with a solid content of 5 wt % (=3:3:7:2), fully mixed and dispersed, and then dried to obtain a double-layer coated silicon-based anode material.

An anode and a preparation method for the anode:

The ratio of the silicon-based anode material according to the present example: graphite:LA133=80:10:10, a water solvent was added and stirred to obtain a slurry with a solid content of 40%, the slurry was evenly coated on the surface of a copper foil, rolled and vacuum-dried at 110° C. overnight to produce an anode sheet.

A lithium-ion battery and preparation method therefor, the preparation method for the lithium-ion battery is as follows:

The anode sheet, a polypropylene microporous separator PP, and a lithium sheet were assembled into a lithium-ion battery, and the electrolyte was the ethylene carbonate EC/ethyl methyl carbonate at 3:7 (V/V), where the concentration of LiPF₆ was 1 mol/L.

### Example 2

This example provides a silicon-based anode material and a preparation method therefor.

The structure of the silicon-based anode material is as in Example 1, which is a core-shell structure having double shell layers.

The preparation method for the silicon-based anode material includes the following steps:

In step S1: 1 kg of silicon monoxide and 100 g of medium-temperature asphalt were placed in a high-temperature anode-coating machine with the introduction of an argon protective atmosphere, and heated at 5° C./min to 200° C., stirred and fused for 2 hrs, and then dynamic high-temperature carbonization for coating was carried out for 5 hours after heating up to 1000° C., and a carbon layer was evenly coated on the surface of the material to obtain a silicon-based core containing a carbon layer. The amount of carbon coating was measured to be 6.5% using a carbon/sulfur analyzer; and

In step S2: 100 g of the silicon-based core containing the carbon layer in the present example was added to 200 g of water-soluble conductive liquid with a solid content of 3 wt % (m_{conductive carbon black}:m_{polyacrylic acid}:m_{carbon nanotube}:m_{graphene}=1:2:1:1.5:0.5), fully mixed and dispersed, and then dried to obtain a double-layer coated silicon-based anode material.

An anode and a preparation method therefor:

The ratio of the silicon-based anode material according to the present example: graphite:LA133=80:10:10, a water solvent was added and stirred to obtain a slurry with a solid content of 40%, the slurry was evenly coated on the surface of a copper foil, rolled and vacuum-dried at 110° C. overnight to produce an anode sheet.

A lithium-ion battery and preparation method therefor, the preparation method for the lithium ion battery is as follows:

The anode sheet, a polypropylene microporous separator PP, and a lithium sheet were assembled into a lithium-ion battery, and the electrolyte was the ethylene carbonate EC/ethyl methyl carbonate at 3:7 (V/V), where the concentration of LiPF₆ was 1 mol/L.

### Example 3

This example provides a silicon-based anode material and a preparation method therefor.

The structure of the silicon-based anode material in the present example is substantially the same as that in Example 1, deferring in that the shell layer of the silicon-based anode material in the present example has a single carbon layer.

The preparation method for the silicon-based anode material includes the following step:

In step S1: 1 kg of silicon monoxide was placed in a high-temperature anode-coating machine with the introduction of an argon protective atmosphere, and heated at 5° C./min to 1050° C., and then dynamic heat preservation was carried out for 1.5 hrs in acetylene/argon mixed gas, and a carbon layer was evenly coated on the surface of the material to obtain a silicon-based core containing the single carbon layer. The amount of carbon coating was measured to be 3.0% using a carbon/sulfur analyzer.

An anode and a preparation method therefor:

The ratio of the silicon-based anode material:graphite:LA133=80:10:10, a water solvent was added and stirred to obtain a slurry with a solid content of 40%, and then the slurry was evenly coated on the surface of a copper foil, rolled and vacuum-dried at 110° C. overnight to produce an anode sheet.

A lithium-ion battery and preparation method therefor, the preparation method for the lithium ion battery is as follows:

The anode sheet, a polypropylene microporous separator PP, and a lithium sheet were assembled into a lithium-ion battery, and the electrolyte was the ethylene carbonate EC/ethyl methyl carbonate at 3:7 (V/V), where the concentration of LiPF₆ was 1 mol/L.

### Example 4

This example provides a silicon-based anode material and a preparation method therefor, and a lithium-ion battery.

The structure of the silicon-based anode material in the present example is substantially the same as that in Example 1, deferring in that the pre-lithiation process in the present example is solid phase sintering; the shell layer includes a lithium silicate layer and a conductive carbon layer, and the conductive carbon layer is coated on the lithium silicate layer. An average thickness of the lithium silicate layer is 3 n, and an average thickness of the conductive carbon layer is 10 nm.

The preparation method for the silicon-based anode material includes the following steps:
In step S1: 1 kg of silicon monoxide was placed in a rotary furnace with the introduction of an argon protective atmosphere, and heated up to 1050° C. at 5° C./min, then a dynamic heat preservation was carried out for 1.5 hrs to obtain a silicon-based core;
In step S2: the above-mentioned silicon-based core was fully mixed with LiH at a molar ratio of 3:1 under an inert atmosphere, and was kept at 200° C. for 2 hrs under an inert atmosphere, heating was continued up to 600° C. and kept for 6 hrs, and then was cooled down; and
In step S3: The following vapor method was used to forma carbon coating layer by vapor deposition on the surface of the pre-silicon-based anode material prepared in step S2: the pre-silicon-based anode material obtained in the above steps was placed in a tube furnace with the introduction of gaseous organic carbon source at 450° C.-900° C. for 0.5 hr-5 hrs, and cooled to room temperature.

An anode and a preparation method therefor:

The silicon-based anode material in Example 4 was directly used as the anode.

A lithium-ion battery and preparation method therefor, the preparation method for the lithium-ion battery is as follows:

The anode of this example, a polypropylene microporous separator PP, and a lithium sheet were assembled into a lithium-ion battery, and the electrolyte was the ethylene carbonate EC/ethyl methyl carbonate at 3:7 (V/V), where the concentration of LiPF_{F} was 1 mol/L.

### Example 5

This example provides a silicon-based anode material and a preparation method therefor, and a lithium-ion battery.

The structure of the silicon-based anode material in the present example is substantially the same as that in Example 4, deferring in that this example adopted electrochemical pre-lithiation; an average thickness of the lithium silicate layer was 3 μm, and an average thickness of the conductive carbon layer was 10 nm.

The preparation method for the silicon-based anode material includes the following steps:
In step S1: 1 kg of silicon monoxide was placed in a rotary furnace with the introduction of an argon protective atmosphere, and heated up to 1050° C. at 5° C./min, then a dynamic heat preservation was carried out for 1.5 hrs to obtain a silicon-based core;
In step S2: a primary battery system was constructed for a redox reaction, a pre-silicon-based anode material containing a pre-lithiation layer coated on the silicon-based core was generated. The battery system included a conductive metal container, an electrolyte in the conductive metal container, and at least a lithium-metal first electrode and lithium-metal second electrode at least inserted in the electrolyte; the lithium-metal first electrode and the lithium-metal second electrode were attached to an inner wall of the conductive metal container respectively, and the electrolyte included ethylene carbonate solvent and lithium hexafluorophosphate with a mass ratio of 98:2; the sheet-shaped silicon-based core obtained from step S1 was immersed in the electrolyte, and was placed close to an end of the lithium metal; and
In step S3: a carbon coating layer was formed on the surface of the pre-silicon-based anode material prepared in step S2 by the following solid phase method: the material obtained in step S2 was mixed evenly with a carbon source in liquid phase to form a conductive carbon coating layer.

An anode and a preparation method therefor:

The silicon-based anode material in Example 5 was directly used as the anode.

A lithium-ion battery and preparation method therefor, the preparation method for the lithium-ion battery is as follows:

The anode of this example, a polypropylene microporous separator PP, and a lithium sheet were assembled into a lithium-ion battery, and the electrolyte was the ethylene carbonate EC/ethyl methyl carbonate at 3:7 (V/V), where the concentration of LiPF_{F} was 1 mol/L.

### Example 6

This example provides a silicon-based anode material and a preparation method therefor, and a lithium-ion battery.

The structure of the silicon-based anode material in the present example is substantially the same as that in Example 4. The core material contains SiOₓ, an average thickness of the lithium silicate layer was 5 μm, and an average thickness of the conductive carbon layer was 15 nm.

The preparation method for the silicon-based anode material includes the following steps:
In step S1: 1 kg of silicon monoxide was placed in a rotary furnace with the introduction of an argon protective atmosphere, and heated up to 1050° C. at 5° C./min, then a dynamic heat preservation was carried out for 1.5 hrs to obtain a silicon-based core;
In step S2: the electrolysis system in Example 5 was constructed to carry out a redox reaction, a pre-silicon-based anode material containing a pre-lithiation layer coated on the silicon-based anode material was generated, the electrolyte included dimethyl maleate and a mixed lithium of lithium oxide and lithium formate with a mass ratio of 90:10; the silicon-based core in step S1 was immersed in the electrolyte, and was close to one end of the lithium metal; and
In step S3: a carbon coating layer was vapor deposited on the surface of the pre-silicon-based anode material prepared in step S2 by the following solid phase method: a conductive carbon coating layer was formed on the surface of the material obtained in step S2 according to the preparation method for carbon nanotubes.

An anode and a preparation method therefor:

The silicon-based anode material in Example 6 was directly used as the anode.

A lithium-ion battery and preparation method therefor, the preparation method for the lithium-ion battery is as follows:

The anode of this example, a polypropylene microporous separator PP, and a lithium sheet were assembled into a lithium-ion battery, and the electrolyte was the ethylene carbonate EC/ethyl methyl carbonate at 3:7 (V/V), where the concentration of LiPF₆ was 1 mol/L.

### Example 7

This example provides a silicon-based anode material and a preparation method therefor, and a lithium-ion battery.

The structure of the silicon-based anode material in the present example is substantially the same as that in Example 1, deferring in that the shell layer in the present example includes a magnesium-containing layer and a carbon layer coated on magnesium-containing layer, and the magnesium-containing layer was coated on the silicon-based core. The magnesium-containing layer had a rich microporous structure, and the pores in the microporous structure were arranged along a direction from the silicon-based core to the carbon layer, and the pore diameter gradually increased from the silicon-based core toward the carbon layer. The average pore diameter was 50 nm, and the material includes a mixture of magnesium oxides, Mg₂SiO₄, and MgSiO₃, with an average thickness of 1 μm; the carbon layer was a vapor-deposited conductive carbon layer, having an average thickness of 30 nm.

The preparation method for the silicon-based anode material includes the following steps:
In step S1: a silicon-based core was prepared according to step S1 of Example 1;
In step S2: the silicon-based core and elemental magnesium nano-powder were prepared into a mixed suspension with a mass ratio of 1:6 of the elemental magnesium:the silicon-based core, and then the mixed suspension was spray-dried to obtain a mixture;
In step S3: the mixture in step S2 was sintered at 600° C. to form a first coated silicon-based particle material containing the silicon-based core and a magnesium-containing coating layer coated on the surface of the silicon-based core;
In step S4: after the sintering treatment in step S3, the sintering temperature in S3 was dynamically maintained, and methane gas with a gas flow rate of 0.5 L/min was introduced for a pyrolysis treatment; a carbon coating layer was formed on the surface of the magnesium-containing coating layer of the first coated silicon-based particle material, which was now referred to as the second coated silicon-based particle material; and
In step S5: the second coated silicon-based particle material was placed in a hydrochloric acid solution with a concentration of 0.5 mol/L for a pickling treatment to obtain the silicon-based anode material.

An anode and a preparation method therefor:

The ratio of the silicon-based anode material:graphite:LA133=80:10:10, a water solvent was added and stirred to obtain a slurry with a solid content of 40%, and then the slurry was evenly coated on the surface of a copper foil, rolled and vacuum-dried at 110° C. overnight to produce an anode sheet.

A lithium-ion battery and preparation method therefor, the preparation method for the lithium-ion battery is as follows:

The anode sheet, a polypropylene microporous separator PP, and a lithium sheet were assembled into a lithium-ion battery, and the electrolyte was the ethylene carbonate EC/ethyl methyl carbonate at 3:7 (V/V) where the concentration of LiPF₆ was 1 mol/L.

### Example 8

This example provides a silicon-based anode material and a preparation method therefor, and a lithium-ion battery.

The structure of the silicon-based anode material in the present example is substantially the same as that in Example 1, deferring in that the shell layer in the present example includes a magnesium-containing layer and a carbon layer coated on the magnesium-containing layer, and the magnesium-containing layer was coated on the silicon-based core. The magnesium-containing layer had a rich microporous structure, and the pores in the microporous structure were arranged along a direction from the silicon-based core to the carbon layer, and the pore diameter gradually increased from the silicon-based core toward the carbon layer. The average pore diameter was 80 nm, and the material includes a mixture of magnesium oxides, Mg₂SiO₄, and MgSiO₃, with an average thickness of 2 μm; the carbon layer was a vapor-deposited conductive carbon layer, having an average thickness of 30 nm.

The preparation method for the silicon-based anode material includes the following steps:
In step S1: a silicon-based core was prepared according to step S1 of Example 1;
In step S2: the silicon-based core was mixed with elemental magnesium and magnesium alloy nano-powders to form a mixed suspension, the ratio of a total mass of the elemental magnesium and magnesium alloy: the mass of silicon-based core was 1:6, and then the mixed suspension was spray-dried to obtain a mixture;
In step S3: the mixture in step S2 was sintered at 1000° C. to form a first coated silicon-based particle material containing the silicon-based core and a magnesium-containing coating layer coated on the surface of the silicon-based core;
In step S4: after the sintering treatment in step S3, the sintering temperature in step S3 was dynamically maintained, and acetylene gas with a gas flow rate of 0.5 L/min was introduced for a pyrolysis treatment; a carbon coating layer was formed on the surface of the magnesium-containing coating layer of the first coated silicon-based particle material, which was now referred to as the second coated silicon-based particle material; and
In step S5: the second coated silicon-based particle material was placed in a hydrochloric acid solution with a concentration of 1 mol/L for a pickling treatment to obtain the silicon-based anode material.

An anode and a preparation method therefor:

The ratio of the silicon-based anode material:graphite:LA133=80:10:10, a water solvent was added and stirred to obtain a slurry with a solid content of 40%, and then the slurry was evenly coated on the surface of a copper foil, rolled and vacuum-dried at 110° C. overnight to produce an anode sheet.

A lithium-ion battery and preparation method therefor, the preparation method for the lithium-ion battery is as follows:

The anode sheet, a polypropylene microporous separator PP, and a lithium sheet were assembled into a lithium-ion battery, and the electrolyte was the ethylene carbonate EC/ethyl methyl carbonate at 3:7 (V/V), where the concentration of LiPF₆ was 1 mol/L.

### Example 9

This example provides a silicon-based anode material and a preparation method therefor, and a lithium-ion battery.

The structure of the silicon-based anode material in the present example is substantially the same as that in Example 1, deferring in that the shell layer in the present example includes a magnesium-containing layer and a carbon layer coated on the magnesium-containing layer, and the magnesium-containing layer was coated on the silicon-based core. The magnesium-containing layer had a rich microporous structure, and the pores in the microporous structure were arranged along a direction from the silicon-based core to the carbon layer, and the pore diameter gradually increased from the silicon-based core toward the carbon layer. The average pore diameter was 60 nm, and the material includes a mixture of magnesium oxides, Mg₂SiO₄, and MgSiO₃, with an average thickness of 3 μm; the carbon layer was a vapor-deposited conductive carbon layer, having an average thickness of 20 nm.

The preparation method for the silicon-based anode material includes the following steps:
In step S1: a silicon-based core was prepared according to step S1 of Example 1;
In step S2: the silicon-based core was mixed with elemental magnesium and magnesium alloy nano-powders to form a mixed suspension, the ratio of a total mass of the elemental magnesium and magnesium alloy:the mass of silicon-based core was 1:6, and then the mixed suspension was spray-dried to obtain a mixture.
In step S3: the mixture in step S2 was sintered at 600° C. to form a first coated silicon-based particle material containing the silicon-based core and a magnesium-containing coating layer coated on the surface of the silicon-based core;
In step S4: after the sintering treatment in step S3, the sintering temperature in step S3 was dynamically maintained, and acetylene gas with a gas flow rate of 0.5 L/min was introduced for a pyrolysis treatment; a carbon coating layer was formed on the surface of the magnesium-containing coating layer of the first coated silicon-based particle material, which was now referred to as the second coated silicon-based particle material; and
In step S5: the second coated silicon-based particle material was placed in a hydrochloric acid solution with a concentration of 1 mol/L for a pickling treatment to obtain the silicon-based anode material.

An anode and a preparation method therefor:

The ratio of the silicon-based anode material:graphite:LA133=80:10:10, a water solvent was added and stirred to obtain a slurry with a solid content of 40%, and then the slurry was evenly coated on the surface of a copper foil, rolled and vacuum-dried at 110° C. overnight to produce an anode sheet.

A lithium-ion battery and preparation method therefor, the preparation method for the lithium-ion battery is as follows:

The anode sheet, a polypropylene microporous separator PP, and a lithium sheet were assembled into a lithium-ion battery, and the electrolyte was the ethylene carbonate EC/ethyl methyl carbonate at 3:7 (V/V), where the concentration of LiPF₆ was 1 mol/L.

### Example 10

This example provides a silicon-based anode material and a preparation method therefor, and a lithium-ion battery.

The structure of the silicon-based anode material in the present example is substantially the same as that in Example 1, deferring in that the shell layer in the present example included a silicon carbide-containing layer and a carbon layer coated on the silicon carbide-containing layer, and the silicon carbide-containing layer was coated on the silicon-based core.

The preparation method for the silicon-based anode material includes the following steps:

1 kg of SiOₓ anode material was placed in a rotary furnace, Ar gas was introduced to replace and completely evacuate gas in the rotary furnace; after the temperature was heated to 750° C. at 5° C./min, the gas was switched to acetylene/Ar mixed gas, and dynamic heat preservation was carried out for 1.5 hrs, so that the surface layer of the material was evenly coated with a carbon layer, the gas was switched again to Ar, and the temperature was further raised to 1200° C. at 5° C./min and kept for 20 min, and the material was took out after cooling to room temperature under the protection of a non-oxidizing gas, and a conductive silicon oxide compounds having a structure of a gradient distribution of silicon microcrystals were obtained, the amount of the carbon coating was measured to be 3.0 wt % by a carbon/sulfur analyzer.

An anode and a preparation method therefor:

The ratio of the silicon-based anode material:graphite:LA133=80:10:10, a water solvent was added and stirred to obtain a slurry with a solid content of 40%, and then the slurry was evenly coated on the surface of a copper foil, rolled and vacuum-dried at 110° C. overnight to produce an anode sheet.

A lithium-ion battery and preparation method therefor, the preparation method for the lithium-ion battery is as follows:

The anode sheet, a polypropylene microporous separator PP, and a lithium sheet were assembled into a lithium-ion battery, and the electrolyte was the ethylene carbonate EC/ethyl methyl carbonate at 3:7 (V/V), where the concentration of LiPF₆ was 1 mol/L.

### Example 11

This example provides a silicon-based anode material and a preparation method therefor, and a lithium-ion battery.

The structure of the silicon-based anode material in the present example is substantially the same as that in Example 1, deferring in that the shell layer in the present example included a silicon carbide-containing layer and a carbon layer coated on the silicon carbide-containing layer, and the silicon carbide-containing layer was coated on the silicon-based core.

The preparation method for the silicon-based anode material includes the following steps:

1 kg of SiOₓ and 80 g of petroleum-based asphalt were mixed evenly by a high-temperature coating machine, and were placed in a rotary furnace, Ar gas was introduced to replace and evacuate the gas in the furnace, the temperature was heated to 1150° C. at 5° C./min and dynamically maintained for 2 hrs, so that the surface of the material is completely carbonized. The material was taken out after cooling to room temperature under the protection of a non-oxidizing gas, and conductive silicon oxide compounds having a structure of a gradient distribution of silicon microcrystals were obtained, and the amount of the carbon coating was measured to be 5.1 wt % by a carbon/sulfur analyzer.

An anode and a preparation method therefor:

The ratio of the silicon-based anode material:graphite:LA133=80:10:10, a water solvent was added and stirred to obtain a slurry with a solid content of 40%, and then the slurry was evenly coated on the surface of a copper foil, rolled and vacuum-dried at 110° C. overnight to produce an anode sheet.

A lithium-ion battery and preparation method therefor, the preparation method for the lithium-ion battery is as follows:

The anode sheet, a polypropylene microporous separator PP, and a lithium sheet were assembled into a lithium-ion battery, and the electrolyte was the ethylene carbonate EC/ethyl methyl carbonate at 3:7 (V/V), where the concentration of LiPF₆ was 1 mol/L.

### Example 12

This example provides a silicon-based anode material and a preparation method therefor, and a lithium-ion battery.

The structure of the silicon-based anode material in the present example is substantially the same as that in Example 1, deferring in that the shell layer in the present example included a silicon carbide-containing layer, a carbon layer coated on the silicon carbide-containing layer, and a polymer layer coated on the carbon layer, and the silicon carbide-containing layer was coated on the silicon-based core.

The preparation method for the silicon-based anode material includes the following steps:

In step S1: 1 kg of SiOₓ was placed in a rotary furnace, Ar gas was introduced to replace and evacuate the gas in the furnace, the temperature was heated to 1000° C. at 5° C./min and the gas was switched to methane/Ar mixed gas, and dynamic heat preservation was carried out for 1.5 hrs, so that the surface layer of the material was evenly coated with a carbon layer; the material was taken out after cooling to room temperature under the protection of a non-oxidizing gas, the powder was placed in a vacuum high-temperature furnace, and the temperature was further raised to 1200° C. at 5° C./min and kept for 20 min, and the material was taken out after cooling to room temperature under the protection of a non-oxidizing gas, and the amount of the carbon coating was measured to be 4.0 wt % by a carbon/sulfur analyzer; and

In step S2: 100 g of the above carbon-coated SiOₓ was added to 300 g of water-soluble conductive liquid with a solid content of 2 wt % (m_{conductive carbon black}:m_{graphene}:m_{carbon nanotube}:m_{PAA}:m_{PVP}=0.7:0.1:0.2:0.7:0.3), fully mixed and dispersed, and then dried to obtain conductive silicon oxide compounds having a structure of a gradient distribution of silicon microcrystals. The amount of the carbon coating was measured to be 7.5 wt % by a carbon/sulfur analyzer.

An anode and a preparation method therefor:

The ratio of the silicon-based anode material:graphite:LA133=80:10:10, a water solvent was added and stirred to obtain a slurry with a solid content of 40%, and then the slurry was evenly coated on the surface of a copper foil, rolled and vacuum-dried at 110° C. overnight to produce an anode sheet.

A lithium-ion battery and preparation method therefor, the preparation method for the lithium-ion battery is as follows:

The anode sheet, a polypropylene microporous separator PP, and a lithium sheet were assembled into a lithium-ion battery, and the electrolyte was the ethylene carbonate EC/ethyl methyl carbonate at 3:7 (V/V), where the concentration of LiPF₆ was 1 mol/L.

### Comparative Example 1

(1) 1 kg of silicon monoxide was placed in a rotary furnace with the introduction of argon gas, the temperature was raised to 720° C. at 5° C./min, the atmosphere was switched to acetylene/Ar mixed gas, and a dynamic heat preservation was carried out for 1.5 hrs, a carbon layer was evenly coated on the surface of the material to obtain a silicon-based core containing the carbon layer. The amount of carbon coating was measured to be 1.8% by a carbon/sulfur analyzer.
(2) 100 g of the above silicon-based core containing the carbon layer was added to 200 g of water-soluble conductive liquid with a solid content of 3 wt % (m_{conductive carbon black}:m_{polyacrylic acid}:m_{carbon nanotube}:m_{PVP}:m_{graphene}=1:2:1:1.5:0.5), fully mixed and dispersed, and then dried to obtain a double-layer coated silicon-based anode material.
(3) Preparation of a lithium-ion battery:

The ratio of the silicon-based anode material:graphite:LA133=80:10:10, a water solvent was added and stirred to obtain a slurry with a solid content of 40%, and then the slurry was evenly coated on the surface of a copper foil, rolled and vacuum-dried at 110° C. overnight to produce an anode sheet.

The anode sheet, a polypropylene microporous separator PP, and a lithium sheet were assembled into a lithium-ion battery, and the electrolyte was the ethylene carbonate EC/ethyl methyl carbonate at 3:7 (V/V), where the concentration of LiPF₆ was 1 mol/L.

### Comparative Example 2

(1) 1 kg of silicon monoxide and 100 g of medium-temperature asphalt were placed in a high-temperature anode-coating machine with the introduction of an argon protective atmosphere, the temperature was heated at 5° C./min to 200° C., stirred and fused for 2 hrs, and then dynamic high-temperature carbonization for coating was carried out for 5 hrs after heating up to 1000° C., and a carbon layer was evenly coated on the surface of the material to obtain a silicon-based core containing the carbon layer. The amount of carbon coating was measured to be 6.5% using a carbon/sulfur analyzer;
(2) 100 g of the above silicon-based core containing the carbon layer was added to 200 g of water-soluble conductive liquid with a solid content of 3 wt % (m_{conductive carbon black}:m_{polyacrylic acid}:m_{carbon nanotube}:m_{PVP}:m_{graphene}=1:2:1:1.5:0.5), fully mixed and dispersed, and then dried to obtain a double-layer coated silicon-based anode material.
(3) Preparation of a lithium-ion battery:

The ratio of the silicon-based anode material:graphite:LA133=80:10:10, a water solvent was added and stirred to obtain a slurry with a solid content of 40%, and then the slurry was evenly coated on the surface of a copper foil, rolled and vacuum-dried at 110° C. overnight to produce an anode sheet.

The anode sheet, a polypropylene microporous separator PP, and a lithium sheet were assembled into a lithium-ion battery, and the electrolyte was the ethylene carbonate EC/ethyl methyl carbonate at 3:7 (V/V), where the concentration of LiPF₆ was 1 mol/L.

### Comparative Example 3

This comparative example provides a carbon-coated silicon-based anode material, a carbon layer is directly coated on SiOₓ and the dynamic heat preservation process as in the step S1 of Example 1 have not been carried out on SiOₓ.

An anode and a preparation method therefore:

The silicon-based anode material of Comparative Example 3 was directly used as the anode.

A lithium-ion battery and a preparation method therefor:

The anode of the present comparative example, a polypropylene microporous separator PP, and a lithium sheet were assembled into a lithium-ion battery, and the electrolyte was the ethylene carbonate EC/ethyl methyl carbonate at 3:7 (V/V), where the concentration of LiPF₆ was 1 mol/L.

Relevant Characteristic Tests

1. Relevant Characteristic Tests of Silicon-Based Anode Material

The distribution of silicon-based anode materials provided by above-mentioned Example 1 to Example 12 and Comparative Example 1 to Comparative Example 3 were characterized and analyzed, and the results are as follows:

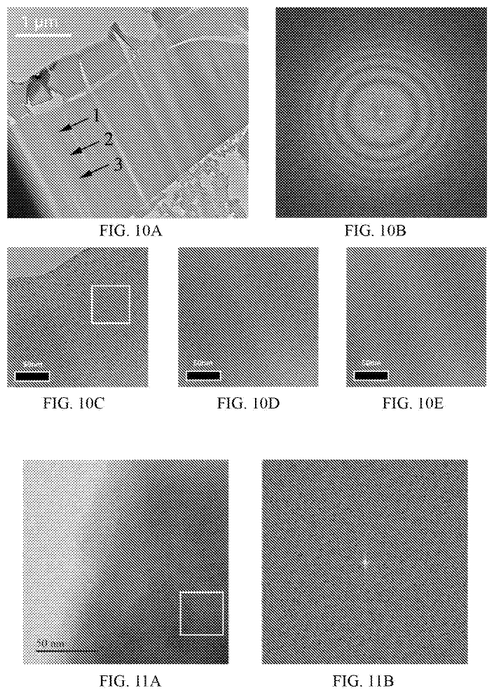

HRTEM characterization were carried out for the silicon-based anode materials of Example 1 and Comparative Example 1. Referring to FIGS. 10A-10E, FIG. 10A is the cross-sectional view of the silicon-based anode material, and positions 1, 2, and 3 indicated by the arrows in the figure represent three sampling points along a direction from the surface of the silicon-based core to the center of the silicon-based core (position 1 is closest to the surface of the silicon-based core), FIG. 10C is the HRTEM image of position 1, FIG. 10D is the HRTEM image of position 2, and FIG. 10E is the HRTEM image of position 3. The selected area in the white box in FIG. 10C was analyzed through Fourier transform to obtain FIG. 10B. From the microcrystal diffraction pattern in FIG. 10B, it can be observed that the black particles are silicon microcrystals, and the more obvious the particles are, the higher the distribution density of the silicon microcrystals is. From the HRTEM images of the three positions, it can be seen that the particles in the HRTEM image of position 1 are the most obvious, that is, the density distribution of silicon microcrystals is the highest at this point, while the particles in positions 2 and 3 gradually decrease, so that the distribution density of silicon microcrystals decreases.

The HRTEM characterization results of the silicon-based anode materials of other examples of the present application are substantially the same as that of Example 1, where the silicon-based cores thereof all contain silicon microcrystals, and the distribution density of the silicon microcrystals gradually decreases along the direction from the surface layer of the silicon-based core to the center of the silicon-based core.

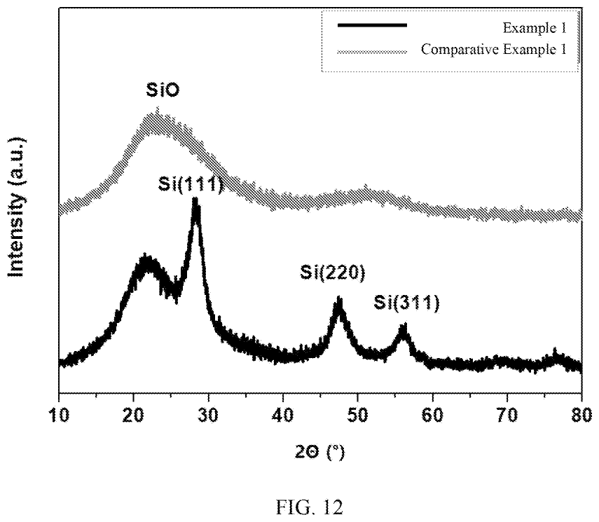

The HRTEM image of the silicon-based anode material of Comparative Example 1 is as shown in FIGS. 11A-11B. FIG. 11A is a high-resolution transmission electron microscope image of the silicon-based anode material of Comparative Example 1, and the selected area of the white frame in FIG. 11A was analyzed using Fourier transform to obtain FIG. 11B. From FIG. 11B The black area is amorphous silicon monoxide, that is, the silicon-based anode material in Comparative Example 1 did not contain silicon microcrystals. XRD analysis were also performed on the silicon-based anode materials of Example 1 and Comparative Example 1. Referring to FIG. 12, it can be seen from FIG. 12 that the silicon-based anode material in Comparative Example 1 did not contain silicon microcrystals. In summary, it can be seen from FIGS. 11A, 11B, and 12 that the silicon-based anode material in Comparative Example 1 did not contain silicon microcrystals, that is, at a lower dynamic heating temperature, disproportionation of silicon monoxide will occur, thereby unable to obtain silicon microcrystals. For the silicon-based anode materials provided in other comparative examples, the presence of silicon microcrystals was not detected either.

The median particle size D50, the carbon content of the silicon-based anode material of Example 1 to Example 12 and Comparative Example 1 to Comparative Example 3 were characterized, and the results are as shown in Table 1.

TABLE 1
physical and chemical properties of the silicon-based anode
materials of the examples and comparative examples.

| | Performance parameters | | | |
|---|---|---|---|---|
| | | Si | | |
| | Number of | microcrystals | | Carbon |
| Example | coating layers | (nm) | D50 (μm) | content (wt %) |
| Example 1 | Double | 4.3 | 4.1 | 6.5 |
| Example 2 | Double | 3.1 | 9.2 | 9.2 |
| Example 3 | Single | 3.1 | 4.1 | 3.0 |
| Example 4 | Double | 3.1 | 8.1 | 4.8 |
| Example 5 | Double | 3.1 | 8.1 | 4.8 |
| Example 6 | Double | 3.1 | 11 | 4.8 |
| Example 7 | Single | 8.7 | 5.2 | 5.1 |
| Example 8 | Single | 9.5 | 5.2 | 5.1 |
| Example 9 | Single | 11.3 | 5.3 | 3.9 |
| Example 10 | Double | 5.2 | 4.1 | 3.0 |
| Example 11 | Double | 4.8 | 4.1 | 5.1 |
| Example 12 | Triple | 4.5 | 4.1 | 7.5 |
| Comparative | Double | / | 3.9 | 5.3 |
| Example 1 | | | | |
| Comparative | Double | 3.7 | 9.0 | 9.0 |
| Example 2 | | | | |
| Comparative | Single | 3 7 | 4.1 | 3.5 |
| Example 3 | | | | |

2. Relevant Characteristic Tests of Lithium-Ion Batteries

The lithium-ion batteries of Example 1 to Example 12 and Comparative Example 1 to Comparative Example 3 was placed at room temperature for 12 hrs, and charging and discharging tests were carried out, with a constant discharging current of 0.1 C to 0.01 V, and a constant discharging current of 0.01 C to 0.01 V, the first cycle discharge capacity was recorded as Q_{discharge}, The batteries were then charged with a current of 0.1 C to a constant voltage of 1.5 V. and the corresponding reversible charge capacity is recorded as Q_{charge}. The first cycle efficiency E=Q_{charge}/Q_{discharge}×100%. The test results are shown in Table 2.

TABLE 2
performance parameters of the lithium-ion batteries
of the examples and comparative examples

| | Performance Parameters | | |
|---|---|---|---|
| | | First cycle | Capacity retaining |
| | First cycle reversible | efficiency | rate after 50 cycles |
| Example | capacity (mAg/h) | (%) | (%) |
| Example 1 | 1600 | 73.3 | 94.7 |
| Example 2 | 1500 | 72.5 | 92.6 |
| Example 3 | 1570 | 73.2 | 91.9 |
| Example 4 | 1310 | 82.1 | 90.1 |
| Example 5 | 1300 | 82.4 | 92.1 |
| Example 6 | 1312 | 83.7 | 91.0 |
| Example 7 | 1457 | 81.2 | 89.5 |
| Example 8 | 1380 | 83.4 | 88.4 |
| Example 9 | 1325 | 84.5 | 87.0 |
| Example 10 | 1450 | 74.3 | 93.2 |
| Example 11 | 1430 | 73.9 | 91.6 |
| Example 12 | 1405 | 74.5 | 93.9 |
| Comparative | 1650 | 73.9 | 87.1 |
| Example 1 | | | |
| Comparative | 1450 | 72.9 | 85.9 |
| Example 2 | | | |
| Comparative | 1550 | 71.7 | 88.3 |
| Example 3 | | | |

As can be seen from Table 2, the first cycle discharge specific capacity of the lithium-ion battery that made of the silicon-based anode material of the present application was larger, and the cycling performance of the battery was better.

The above descriptions are merely some embodiments of the present application and are not intended to limit the present application. It should be noted that those skilled in the art can make several modifications and improvements without departing from the concept of the present application, and these modifications and improvements all belong to the protection scope of the present application. Therefore, the scope of protection of the patent application should be based on the appended claims.

What is claimed is:

1. A silicon-based anode material, comprising:
a silicon-based core; and
a shell layer arranged on the silicon-based core,
wherein the silicon-based core comprises SiOₓ and silicon microcrystals dispersed in the SiOₓ, and wherein 0.9≤x≤1.3; and
wherein a distribution density of the silicon microcrystals gradually decreases along a direction from a surface of the silicon-based core to a center of the silicon-based core, and the shell layer includes a carbon layer.

2. The silicon-based anode material according to claim 1, wherein a ratio of the distribution density of the silicon microcrystals on the surface of the silicon-based core, Dₒᵤₜ₁, to the distribution density of the silicon microcrystals at a depth of 500 nm from the surface of the silicon-based core toward the center of the silicon-based core, Dᵢₙ₁, is 0≤Dᵢₙ₁/Dₒᵤₜ₁<1; and/or
a size of the silicon microcrystals is 1 nm-20 nm; and/or
in any cross-section of the silicon-based anode material, a total area of the silicon microcrystals accounts for 1%-23% of a total area of the silicon-based core; and/or
the size of silicon microcrystals gradually increases along a direction from the center of the silicon-based core toward the surface of the silicon-based core; and/or
the shell layer further comprises a transition layer coated on the silicon-based core, and the carbon layer is coated on the transition layer, the transition layer contains at least one element of lithium, magnesium, and sodium.

3. The silicon-based anode material according to claim 2, wherein a ratio of a particle size of the silicon microcrystals on the surface of the silicon-based core, Dₒᵤₜ₂, to a particle size of the silicon microcrystals at the depth of 500 nm from the surface of the silicon-based core toward the center of the silicon-based core, Dᵢₙ₂, is 0≤Dᵢₙ₂/Dₒᵤₜ₂<1;
wherein the transition layer comprises any one of a pre-lithiation layer, a magnesium-containing layer, a silicon carbide-containing layer, a composite layer of the pre-lithiation layer and the magnesium-containing layer, and a composite layer of the pre-lithiation layer and the silicon carbide-containing layer,
wherein when the transition layer comprises the pre-lithiation layer, the pre-lithiation layer is coated on the silicon-based core, and the carbon layer is coated on the pre-lithiation layer;
wherein when the transition layer comprises the magnesium-containing layer, the magnesium-containing layer is coated on the silicon-based core, and the carbon layer is coated on the magnesium-containing layer;
wherein when the transition layer comprises the silicon carbide-containing layer, the silicon carbide-containing layer is coated on the silicon-based core, and the carbon layer is coated on the silicon carbide-containing layer;
wherein when the transition layer comprises the composite layer of the pre-lithiation layer and the magnesium-containing layer, the pre-lithiation layer is coated on the silicon-based core, the magnesium-containing layer is coated on the pre-lithiation layer, and the carbon layer is coated on the magnesium-containing layer; and
wherein when the transition layer comprises the composite layer of the pre-lithiation layer and the silicon carbide-containing layer, the pre-lithiation layer is coated on the silicon-based core, the silicon carbide-containing layer is coated on the pre-lithiation layer, and the carbon layer is coated on the silicon carbide-containing layer.

4. The silicon-based anode material according to claim 3, wherein a pre-lithiation material of the pre-lithiation layer comprises at least one of Li₂SiO₃, Li₄SiO₄, and Li₂SiO₅; and/or
a thickness of the pre-lithiation layer is 50 nm-5 μm.

5. The silicon-based anode material according to claim 3, wherein a thickness of the magnesium-containing layer is 50 nm-5 μm; and/or
a microporous structure is distributed in the magnesium-containing layer; and/or
a material of the magnesium-containing layer comprises at least one of magnesium oxides, Mg₂SiO₄, MgSiO₃, magnesium hydroxides, and magnesium alloys.

6. The silicon-based anode material according to claim 5, wherein a spacing between two adjacent pores in the microporous structure is 10 nm-500 nm; and/or
an aperture of the pores in the microporous structure is 10 nm-500 nm.

7. The silicon-based anode material according to claim 1, wherein a particle size of the silicon microcrystals is calculated to be in a range of 1 nm-20 nm using the Scherrer formula; and/or
a median particle size D50 of the SiOₓ is 0.5 μm-15 μm, D10/D50≥0.3, and D90/D50≤2; and/or
a median particle size D50 of the silicon-based core is 0.5 μm≤D50≤15 μm, D10/D50≥0.3, and D90/D50≤2; and/or
a thickness of the carbon layer is 0.5 nm-100 nm; and/or
the shell layer further comprises a polymer layer arranged on the carbon layer, and the polymer layer comprises a polymer; and/or
a specific surface area of the silicon-based anode material is 1 m²/g-10 m²/g.

8. The silicon-based anode material according to claim 2, wherein a particle size of the silicon microcrystals is calculated to be in a range of 1 nm-20 nm using the Scherrer formula; and/or
a median particle size D50 of the SiOₓ is 0.5 μm-15 μm, D10/D50≥0.3, and D90/D50≤2; and/or
a median particle size D50 of the silicon-based core is 0.5 μm≤D50≤15 μm, D10/D50≥0.3, and D90/D50≤2; and/or
a thickness of the carbon layer is 0.5 nm-100 nm; and/or
the shell layer further comprises a polymer layer arranged on the carbon layer, and the polymer layer comprises a polymer; and/or
a specific surface area of the silicon-based anode material is 1 m²/g-10 m²/g.

9. The silicon-based anode material according to claim 3, wherein a particle size of the silicon microcrystals is calculated to be in a range of 1 nm-20 nm using the Scherrer formula; and/or
a median particle size D50 of the SiOₓ is 0.5 μm-15 μm, D10/D50≥0.3, and D90/D50≤2; and/or
a median particle size D50 of the silicon-based core is 0.5 μm≤D50≤15 μm, D10/D50≥0.3, and D90/D50≤2; and/or
a thickness of the carbon layer is 0.5 nm-100 nm; and/or
the shell layer further comprises a polymer layer arranged on the carbon layer, and the polymer layer comprises a polymer; and/or
a specific surface area of the silicon-based anode material is 1 m²/g-10 m²/g.

10. The silicon-based anode material according to claim 7, wherein the polymer comprises one or more of an organic polymer having a structure of [CH₂—CF₂]ₙ—, an organic polymer having a structure of (C₆H₇O₆Na)ₙ, an organic polymer having a structure of [C₆H₇O₂(OH)₂OCH₂COONa]ₙ, an organic polymer having a structure of [C₃H₃O₂M]ₙ, an organic polymer having a structure of (C₃H₃N)ₙ, an organic polymer having an amide bond (—NHCO—), and an organic polymer containing an imide ring (—CO—N—CO—) in a main chain; and/or
the polymer layer further comprises a conductive agent, and the conductive agent comprises one or more of carbon black, graphite, mesocarbon microspheres, carbon nanofibers, carbon nanotubes, C60, and graphene; a mass ratio of the conductive agent to the polymer in the polymer layer is (0.5-5):1; and/or
a mass of the polymer layer accounts for 1%-20% of a total mass of the silicon-based anode material.

11. A preparation method for a silicon-based anode material, comprising:
performing a dynamic heat treatment on silicon monoxide to obtain a silicon-based core, wherein the silicon-based core comprises SiOₓ and silicon microcrystals dispersed in the SiOₓ, and wherein 0.9≤x≤1.3, and a distribution density of the silicon microcrystals gradually decreases along a direction from a surface of the silicon-based core to a center of the silicon-based core; and
forming a shell layer on the silicon-based core to obtain the silicon-based anode material, wherein the shell layer comprises a carbon layer.

12. The preparation method according to claim 11, wherein a temperature of the dynamic heat treatment is 800° C.-1300° C.; and/or
before forming the shell layer on the silicon-based core, the method further comprises forming a transition layer on the silicon-based core, and the transition layer contains at least one element of lithium, magnesium, and sodium.

13. The preparation method according to claim 12, wherein the transition layer comprises a pre-lithiation layer, and the step of forming the transition layer on the silicon-based core comprises:
immersing the silicon-based core into an electrolyte containing a lithium salt, constructing a primary battery with the electrolyte and an electrode, so that a reduction reaction occurs in the electrolyte to generate a layer containing a pre-lithiation material on the silicon-based core; or
immersing the silicon-based core in the electrolyte containing a lithium salt, and electrolyzing the electrolyte so that a reduction reaction occurs in the electrolyte to generate a layer containing a pre-lithiation material on the silicon-based core; or
coating a solution of a precursor of a pre-lithiation material on the silicon-based core, and sintering to generate a layer containing the pre-lithiation material on the silicon-based core; or
depositing a precursor of a pre-lithiation material on the silicon-based core through chemical vapor deposition to initiate a reduction reaction, so that a layer containing the pre-lithiation material is generated on the silicon-based core; or
depositing a pre-lithiation material through physical vapor deposition to generate a layer containing the pre-lithiation material on the silicon-based core.

14. The preparation method according to claim 12, wherein the transition layer comprises a magnesium-containing layer, and the step of forming the transition layer on the silicon-based core comprises:
mixing a powder of a magnesium-containing material with the silicon-based core to form a mixture containing silicon and magnesium;
sintering the mixture to form a magnesium-containing coating layer on the silicon-based core to obtain a first coated silicon-based particle material, wherein a sintering temperature is a temperature at which the silicon-based core reacts with magnesium;
forming the carbon layer on a surface of the first coated silicon-based particle material to obtain a second coated silicon-based particle material; and
pickling the second coated silicon-based particle material, and etching the magnesium-containing coating layer to form a microporous structure, so as to form the magnesium-containing layer.

15. The preparation method according to claim 12, wherein the transition layer comprises a silicon carbide-containing layer, and the step of forming the transition layer on the silicon-based core comprises:
introducing a carbon source to continue reactions during a dynamic heat preservation process in an inert atmosphere and at a temperature of 700° C.-300° C., and forming the silicon carbide-containing layer and the carbon layer on the surface of the silicon-based core; or
performing a pyrolysis treatment on a carbon source under an inert atmosphere at 700° C.-1000° C. to form a carbonized layer on the silicon-based core; and heating the temperature up to 1000° C.-1300° C. for the dynamic heat preservation treatment, such that a reaction occurs at an interface between the carbonized layer and the silicon-based core to form silicon carbide, thereby forming the silicon carbide-containing layer.

16. The preparation method according to claim 12, wherein the transition layer comprises a composite layer of a pre-lithiation layer and a magnesium-containing layer, and the step of forming the transition layer on the silicon-based core comprises:
forming the pre-lithiation layer on the silicon-based core, wherein the step comprises:
immersing the silicon-based core into an electrolyte containing a lithium salt, constructing a primary battery with the electrolyte and an electrode, so that a reduction reaction occurs in the electrolyte to generate a layer containing a pre-lithiation material on the silicon-based core; or
immersing the silicon-based core in the electrolyte containing a lithium salt, and electrolyzing the electrolyte so that a reduction reaction occurs in the electrolyte to generate a layer containing a pre-lithiation material on the silicon-based core; or
coating a solution of a precursor of a pre-lithiation material on the silicon-based core, and sintering to generate a layer containing the pre-lithiation material on the silicon-based core; or
depositing a precursor of a pre-lithiation material on the silicon-based core through chemical vapor deposition to initiate a reduction reaction, so that a layer containing the pre-lithiation material is generated on the silicon-based core; or
depositing a pre-lithiation material through physical vapor deposition to generate a layer containing the pre-lithiation material on the silicon-based core; and
forming the magnesium-containing layer on the pre-lithiation layer, wherein the step comprises:
mixing a powder of a magnesium-containing material with the silicon-based core to form a mixture containing silicon and magnesium;
sintering the mixture to form a magnesium-containing coating layer on the silicon-based core to obtain a first coated silicon-based particle material, wherein a sintering temperature was a temperature at which the silicon-based core reacts with magnesium;
forming the carbon layer on a surface of the first coated silicon-based particle material to obtain a second coated silicon-based particle material; and
pickling the second coated silicon-based particle material, and etching the magnesium-containing coating layer to form a microporous structure, so as to form the magnesium-containing layer.

17. The preparation method according to claim 12, wherein the transition layer comprises a composite layer of a pre-lithiation layer and a silicon carbide-containing layer, and the step of forming the transition layer on the silicon-based core comprises:
forming the pre-lithiation layer on the silicon-based core, wherein the step comprises:
immersing the silicon-based core into an electrolyte containing a lithium salt, constructing a primary battery with the electrolyte and an electrode, so that a reduction reaction occurs in the electrolyte to generate a layer containing a pre-lithiation material on the silicon-based core; or
immersing the silicon-based core in the electrolyte containing a lithium salt, and electrolyzing the electrolyte so that a reduction reaction occurs in the electrolyte to generate a layer containing a pre-lithiation material on the silicon-based core; or
coating a solution of a precursor of a pre-lithiation material on the silicon-based core, and sintering to generate a layer containing the pre-lithiation material on the silicon-based core; or
depositing a precursor of a pre-lithiation material on the silicon-based core through chemical vapor deposition to initiate a reduction reaction, so that a layer containing the pre-lithiation material is generated on the silicon-based core; or
depositing a pre-lithiation material through physical vapor deposition to generate a layer containing the pre-lithiation material on the silicon-based core; and
forming the silicon carbide-containing layer on the pre-lithiation layer comprises:
introducing a carbon source to continue reactions during a dynamic heat preservation process in an inert atmosphere and at a temperature of 700° C.-1300° C., and forming the silicon carbide-containing layer and the carbon layer on the surface of the silicon-based core; or
performing a pyrolysis treatment on a carbon source under an inert atmosphere at 700° C.-1000° C. to form a carbonized layer on the silicon-based core; and heating the temperature up to 1000° C.-1300° C. for the dynamic heat preservation treatment, such that a reaction occurs at an interface between the carbonized layer and the silicon-based core to form silicon carbide, thereby forming the silicon carbide-containing layer.

18. The preparation method according to claim 12, further comprising:
forming a polymer layer on the carbon layer of the shell layer, after forming the carbon layer on the silicon-based core, wherein the polymer layer comprises a polymer, and the polymer comprises one or more of an organic polymer having a structure of [CH₂—CF₂]ₙ—, an organic polymer having a structure of (C₆H₇O₆Na)ₙ, an organic polymer having a structure of [C₆H₇O₂(OH)₂OCH₂COONa]ₙ, an organic polymer having a structure of [C₃H₃O₂M]ₙ, an organic polymer having a structure of (C₃H₃N)ₙ, an organic polymer having an amide bond (—NHCO—), and an organic polymer containing an imide ring (—CO—N—CO—) in a main chain.

19. An anode, comprising a current collector and a silicon-based active layer bonded to a surface of the current collector,
wherein the silicon-based active layer contains the silicon-based anode material according to claim 1.

20. A secondary battery, comprising the anode according to claim 19.
